(19) United States
(12) Patent Application Publication
(10) Pub. No.: US 2016/0332623 A1
(43) Pub. Date: Nov. 17, 2016

(54) SYSTEMS AND METHODS FOR VEHICULAR ROUTE OPTIMIZATION

(71) Applicant: Richard Gary John Baverstock, Gilroy, CA (US)

(72) Inventor: Richard Gary John Baverstock, Gilroy, CA (US)

(21) Appl. No.: 15/152,326

(22) Filed: May 11, 2016

Related U.S. Application Data
(60) Provisional application No. 62/162,215, filed on May 15, 2015.
(60) Provisional application No. 62/162,258, filed on May 15, 2015.
(60) Provisional application No. 62/162,287, filed on May 15, 2015.

(51) Int. Cl. B60W 30/14; B60W 10/06; B60W 10/18; B60W 10/10

(52) U.S. Cl. CPC B60W 30/143; B60W 10/10; B60W 10/06; B60W 10/18; B60W 2420/52; B60W 2420/42; B60W 2540/28; B60W 2550/13; B60W 2550/12; B60W 2550/14; B60W 2550/20; B60W 2550/402; B60W 2550/408; B60W 2550/404; B60W 2710/0644; B60W 2710/081; B60W 2710/10; B60W 2710/18

(57) ABSTRACT

A vehicular glide solver receives a requested route defined by at least one route parameter. The solver optimizes the requested route using vehicular optimization criteria. The optimization includes analysis of at least one data set pertaining to the requested route, and provides a vehicular glide schedule for discrete points along the requested route in response to the route optimization. The solver dynamically adjusts the vehicular glide schedule in response to a change in one of the at least one data set.

### CROSS REFERENCE TO RELATED APPLICATIONS

This application claims priority from U.S. Provisional Application No. 62/162,215 filed on May 15, 2015, entitled “Route Based Vehicle Speed Optimization for Fuel Efficiency”, which is hereby fully incorporated by reference. This application also claims priority from U.S. Provisional Application No. 62/162,258 filed on May 15, 2015, entitled “Route Aware Speed Control for Fuel Efficiency”, which is hereby fully incorporated by reference. This application further claims priority from U.S. Provisional Application No. 62/162,287 filed on May 15, 2015, entitled “Elevation Querying System”, which is hereby fully incorporated by reference.

Further, this application is related to co-pending U.S. application Ser. No. ______, (Attorney Docket Number MGL-1602-US) filed May 11, 2016, entitled “Elevation Query Systems for Vehicular Route Optimization and Methods thereof”, which is hereby fully incorporated by reference.

Additionally, this application is related to co-pending U.S. application Ser. No. ______, (Attorney Docket Number MGL-1603-US) filed May 11, 2016, entitled “System and Methods for Efficient Resource Management During Vehicular Journeys”, which is hereby fully incorporated by reference.

### BACKGROUND

The present invention relates to systems and methods for efficiently deploying valuable resources, such as cost and duration, especially during extended vehicular trips.

While many vehicles available today offer conveniences such as cruise control, they provide few options for assisting drivers interested in dynamically optimizing fuel efficiency. For example, cruise control works reasonably well for maintaining a constant speed on a straight and flat interstate freeway with moderate traffic. In newer and better equipped vehicles, adaptive cruise control enables these drivers to maintain appropriately safe spacing between vehicles when the vehicle ahead changes speed, while lane departure warning system alerts inattentive drivers who drift from their intended lane of traffic. However, the general goal of the current vehicular control systems is to minimize driver workload and/or to enhance driver safety.

Some driver-agnostic and route-agnostic attempts at reducing fuel consumption do exist, and they include “one-size-fits-all” strategies such as capping the rate of acceleration or shifting gears at more efficient preset speeds, often marketed as “ECO” driving mode. However these “ECO” modes substantially compromise vehicular performance, and also ignore individual driver preferences and actual routes driven, thereby adversely impacts drivers' overall experience.

It is therefore apparent that an urgent need exists for systems and methods targeted at increasing efficiency of vehicles while dynamically taking into consideration real-time route characteristics. With the average cost of new cars in the United States now exceeding $30,000, existing vehicles are expected to remain in service for ten or more years. Hence, in addition to improving the dynamic efficiency of new vehicles, such improved systems and methods enable a large number of existing vehicles to be retrofitted and transformed into dynamically efficient vehicles.

### SUMMARY

To achieve the foregoing and in accordance with the present invention, systems and methods for dynamically and efficiently operating a vehicle along a route in real-time is provided.

In one embodiment, a vehicular glide solver receives a requested route defined by at least one route parameter. The solver optimizes the requested route using vehicular optimization criteria, wherein the optimization includes analysis of at least one data set pertaining to the requested route, and provides a vehicular glide schedule for discrete points along the requested route in response to the route optimization. The solver dynamically adjusts the vehicular glide schedule in response to a change in one of the at least one data set.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1-4 are block diagrams illustrating one embodiment of a dynamic vehicular resource optimization system in accordance with the present invention;

FIGS. 5-7 are flowcharts illustrating the embodiment of the dynamic vehicular resource optimization system of FIGS. 1-4;

FIGS. 8A-8C are block diagrams illustrating three alternative implementations of a glide controller for the dynamic vehicular resource optimization system of FIGS. 1-4;

FIGS. 9 and 10A-10B illustrate one embodiment of an elevatier for the dynamic vehicular resource optimization system of FIGS. 1-4; and

FIGS. 11-13 are screenshots illustrating the embodiment of the dynamic vehicular resource optimization system of FIGS. 1-4.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for optimizing a vehicle's route and Glide schedule using information related but not limited to traffic, time, cost, weather, vehicular sensor data, cost, and refueling/recharging. In particular, the present invention is directed to the novel methods and systems to optimize the route of a transportation vehicle based on optimization preferences, and provide the vehicle user and the vehicle with an optimized route based on the optimization preferences. Additionally, the present invention is directed to the novel methods and systems that enable a user to temporarily relinquish acceleration and braking (regenerative deceleration, engine braking, and friction braking) to the present invention for the purpose of increasing a vehicle's efficiency and optimizing one or more of a vehicle route's parameters (e.g. time, cost); this could be thought of as an advanced or “smart” cruise control. Additionally, the present invention is directed to the novel methods and systems that enable a transportation infrastructure (namely vehicular) to optimize one of many parameters, including but not limited to, traffic flow, total throughput, and lane avoidance/clearance, by providing vehicles with instructions directed at how to manipulate driving behaviors.

The following discussion serves to explain the methods and systems of the present invention. There are multiple examples throughout the discussion that aid in the explanation of certain features or methods the present invention has or uses. For example, this discussion is primarily centered on the automotive transportation industry and movement in 2-dimensional space (constrained to roads). This should not limit the scope of application for the present invention. The systems and methods described here may be applied to planes, boats, submersibles, and spacecraft. Many of these modes of transportation are not limited in movement to 2-dimensions; it follows that the discussion should not limit the present invention to operating in the vehicle transportation sector, nor in 2-dimensional space.

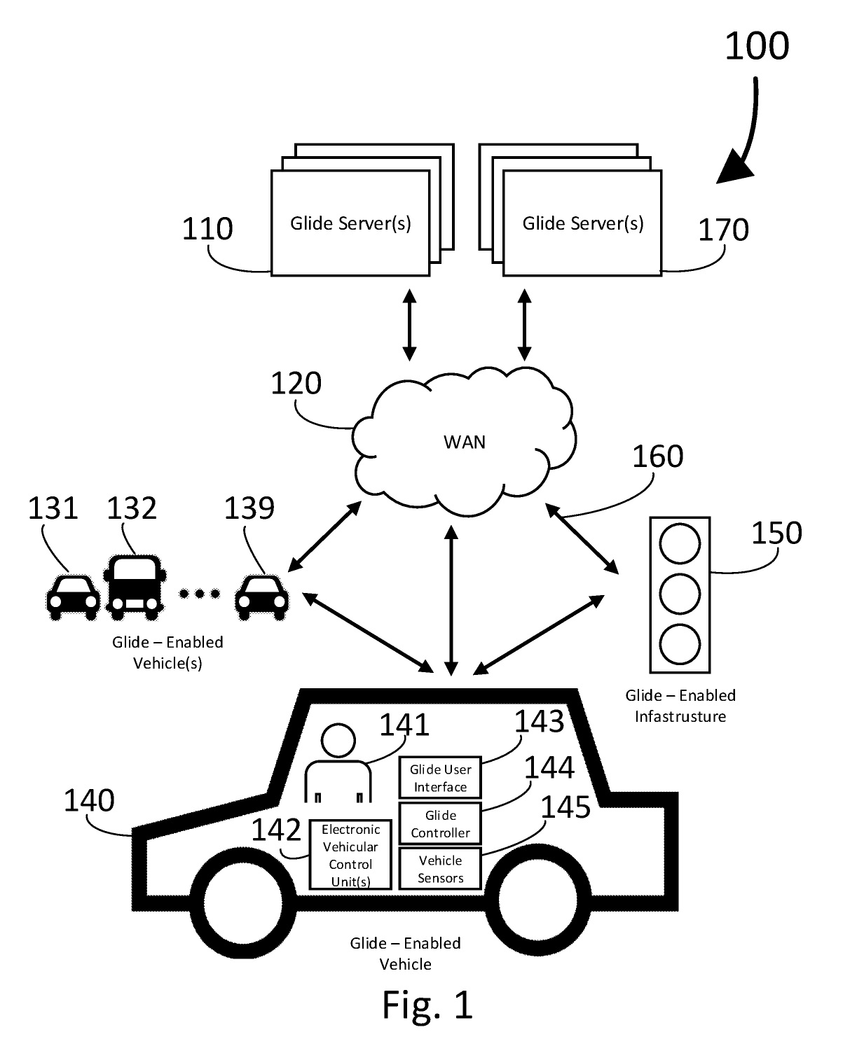

FIG. 1 shows one possible embodiment of the Glide System 100. Communication between the Glide Servers 110, 170 and Glide enabled devices 131, 132 . . . 139, 140, 150 may occur over a WAN (Wide Area Network) 120. Although FIG. 1 depicts Glide enabled devices 131, 132 . . . 139, 140, 150 as motorized vehicles and traffic related infrastructure, this should not limit the scope of Glide enabled devices.

There may be multiple instances of the Glide Servers 110, 170. These different instances of the servers may serve different purposes or may store different data. As an example, one set of Glide Servers 110 may be responsible for data pertaining to route optimization, while another instance of the Glide Servers 170 may be responsible only for providing firmware updates to Glide Controllers 144. This may mean that a Glide Controller 144 will access Glide Servers 110 exclusively when performing route optimization. It would then follow that, when requesting firmware updates or periodic (monthly, quarterly, yearly) data refreshing, a Glide Controller 144 may only access Glide Server 170.

Throughout the rest of this discussion, Glider Servers 110 in FIG. 1 will be referenced when route data is being discussed, and Glider Servers 170 in FIG. 1 will be referenced when firmware updates and locally stored data refreshing are being discussed. This distinction between the two different blocks of FIG. 1 should in no way limit the number or responsibilities of different instances of the Glide Servers.

Communication 160 in the Glide System 100 may happen between Glide enabled devices 131, 132 . . . 139, 140, 150 and the Glide Servers 110, 120 or between Glide enabled devices 131, 132 . . . 139, 140, 150. Communication 160 should not be limited to the above two cases. Communication 160 in the Glide System 100 may include but is not limited to, 4G and 5G cellular communication, DSRC, WiFi, ZigBee, and Bluetooth.

There may be multiple mode variations that a Glide Controller 144 may operate in. These may include but are not limited to, a subscription-based model; a stand-alone configuration; and OEM licensed software. The mode variation that a Glide Controller 144 is operating in may determine the Glide Servers 110, 170 that specific Glide Controller 144 has access to.

In the subscription-based model, the Glide Controller 144 in a Glide enabled device 131, 132 . . . 139, 140, 150 may send and receive pertinent data to and from the Glide Servers 110 to be used to optimize a route for the desired parameters. The subscription based model may allow Glide Controllers 144 to communicate 160 in real-time with the Glide Servers 110 to gain new information pertinent to solving the route optimization. This model may be similar to OnStar systems where the user 141 may pay a subscription fee for continuous use of the Glide Servers 110.

In the stand-alone application, the Glide Controller 144 in the Glide enabled device 131, 132 . . . 139, 140, 150 may not communicate 160 with the Glide Servers 110, but may rather solve the route optimization using data included locally on the Glide Controller 144. In this way, the Glide Controller 144 would not receiver data from the Glide Servers 110 that is pertinent to solving the route optimization. This stand-alone configuration may allow for a Glide Controller 144 to download firmware updates from the Glide Servers 170. These firmware updates may include firmware that runs on a Glide Controller 144 as well as updates to the data stored locally on the Glide Controller 144 that the controller uses to solve the route optimization. This model may be compared to a GPS unit where the unit periodically downloads updates, but it relies on internal data for functionality.

A third possibility is for the Glide Controller 144 to be licensed to OEM (Original Equipment Manufacturers) for use in propriety or “in-house” developed products. An example of this may be the Glide software being installed directly into the electronic vehicular control unit (e.g. ECU) 142 of an OEM vehicle instead of as an after-market add-on. In this realization, the Glide functionality may operate in either the connected or stand-alone mode.

These three models should not be considered the only embodiment variations that Glide Controllers 144 may operate in. It should be noted that all embodiments of the Glide System 100 may include the ability to solve the route optimization problem, regardless of if it is a connected system, stand-alone, licensed to an outside party or any other embodiment the system might assume.

I. User and/or Vehicle Interfaces

FIG. 1 shows the Glide System 100 with Glide enabled devices 131, 132 . . . 139, 140, 150. Glide enabled vehicle 140 shows that the Glide Controller 144 may include a Glide User Interface 143. The Glide User Interface 143 may refer generally to a module capable of providing the user 141 a way to import route information into the Glide Controller 144. More specifically, the Glide User Interface 143 may be a visual feedback device with tactile or virtual buttons capable of reading data in and outputting data.

The Glide User Interface 143 may be a user's 141 cellular device, tablet or laptop computer. The Glide User Interface 143 may not necessarily be installed in the Glide enabled device 140, but may be a device that is connected via a wireless communications protocol and WAN to the Glide Controller 144, the Glide enabled device 140, or the Glide WAN 120. In this way, the Glide Controller 144 may be controlled remotely (outside of the Glide enabled device 140).

The Glide User Interface 143 may be used to receive route parameters, preferences and general data from the User 141; it may also be used to display information to the User 141. Information that the Glide User Interface 143 may report the user may include but is not limited to, trip duration; estimated time of arrival (ETA); trip cost (tolls, fuel consumption cost, etc.); current vehicle speed; next target speed; next target location; trip efficiency normalized by distance relative to other trips taken; trip efficiency normalized by distances relative to the same trip taken without the Glide System 100; the next driving instruction; or warning of hazards along the route.

The information that the Glide User Interface 143 may display should in no way be limited by the above list. The Glide User Interface 143 may also be integrated into the vehicle's infotainment suite. In this realization, the Glide User Interface 143 may be tasked with displaying other vehicle related information including but not limited to, navigation maps and directions; maintenance alerts; and entertainment related information.

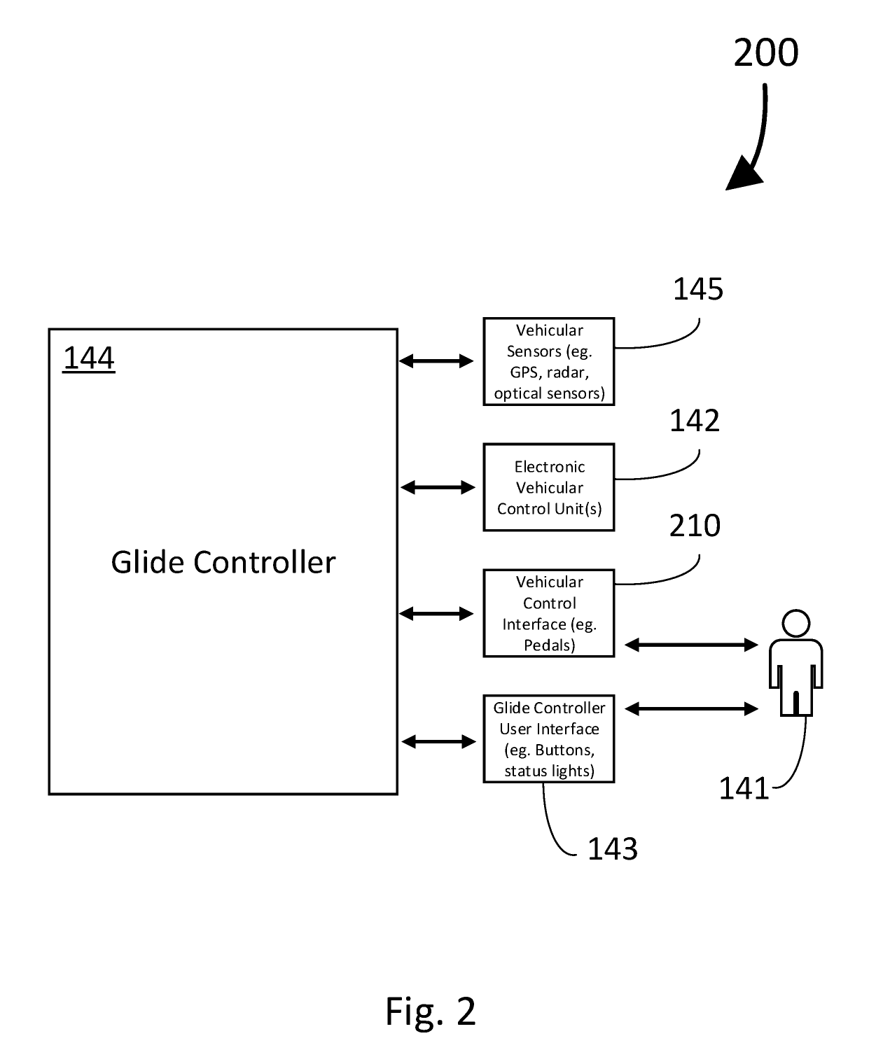

FIG. 2 shows how a Glide Controller 144 may interface with the Glide enabled device 131, 132 . . . 139, 140, 150 that it is installed into and the user 141 of that device (if applicable). The Glide Controller may communicate with multiple vehicle peripheral systems 145, 142, 210, 143 including but not limited to, vehicular sensors (e.g. GPS, radar, optical sensors, wheel speed sensors, accelerometers, gyroscopes and strain gauges) 145; the electronic vehicular control unit (e.g. ECU and cruise control specific controller) 142; and the vehicular control interface (e.g. accelerator and brake pedals and cruise controls) 210.

FIG. 2 depicts the data between the Glide Controller 144 and vehicle's peripherals 145, 142, 210, 143 may be bidirectional. In this case, the Glide Controller 144 may take information from the peripherals while also sending data to or manipulating them.

The Glide Controller 144 may integrate into the Glide enabled device 131, 132 . . . 139, 140, 150 in multiple ways. The following discussion is specific to integration into a vehicle but may also apply for integration into other devices; further, it should not be concluded that these are the only ways the Glide Controller 144 may integrate into a physical system.

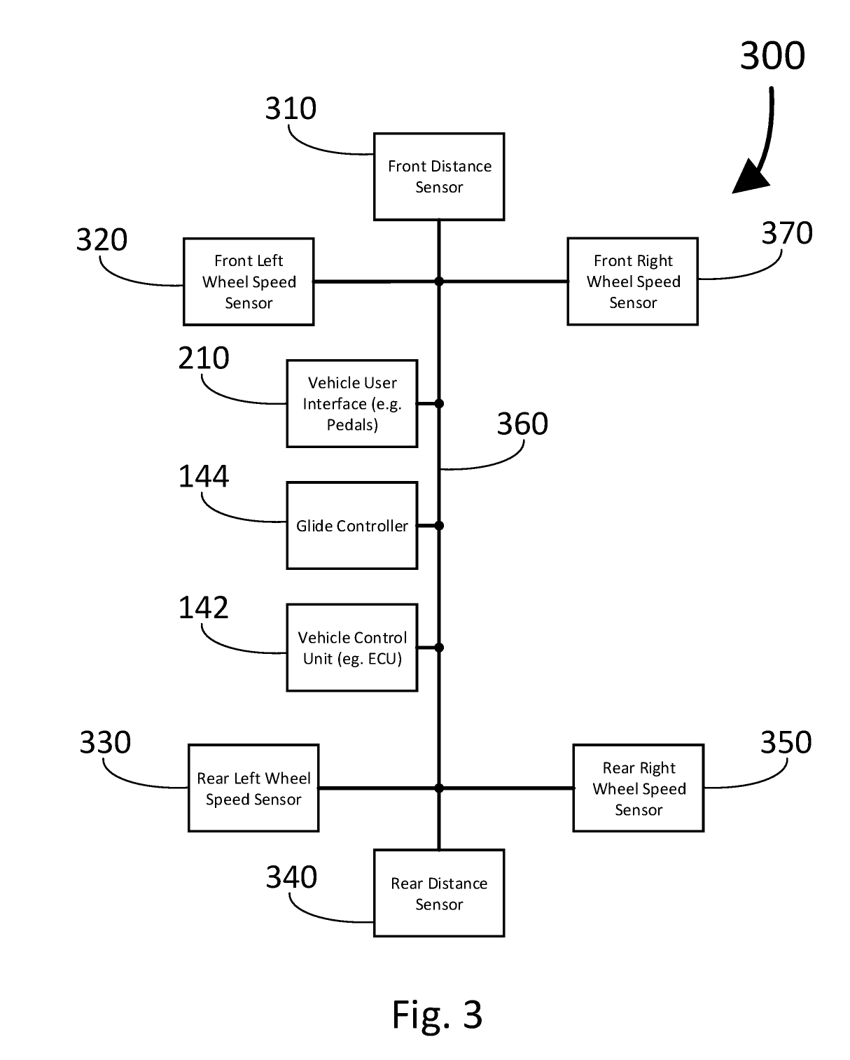

FIG. 3 shows one way the Glide Controller 144 may be integrated into the electronics of a vehicle. The Glide Controller 144 may be connected to any of or multiple of the vehicle's CAN busses 360, which means it may be able to take data from and inject data onto the vehicle's communication bus 360. In this way, the Glide Controller 144 may be able to manipulate the throttle request of the vehicle by adding specific messages onto the CAN bus 360. In addition to manipulating the throttle request, the Glide Controller 144 may be able to manipulate other sensors or modules in the vehicle. Other information the Glide Controller 144 may manipulate may include but is not limited to, Batter Management System information (tractive battery voltage, tractive battery current, output and input tractive battery power); cylinder activation; braking (regenerative deceleration, engine braking, friction braking); gear and neutral selection; 4 wheel, 2 wheel, and all-wheel drive selection; enabling and disabling manufacturer eco modes; and specifying a power plant to use (electric or gas) in hybrid systems. This may also allow the Glide Controller 144 to collect information from the vehicular sensors 310, 320, 330, 340, 350, 370. The vehicular sensors shown in FIG. 3 are representative only and should not limit the quantity or scope of the sensors that a Glide Controller 144 may take information from or give information to.

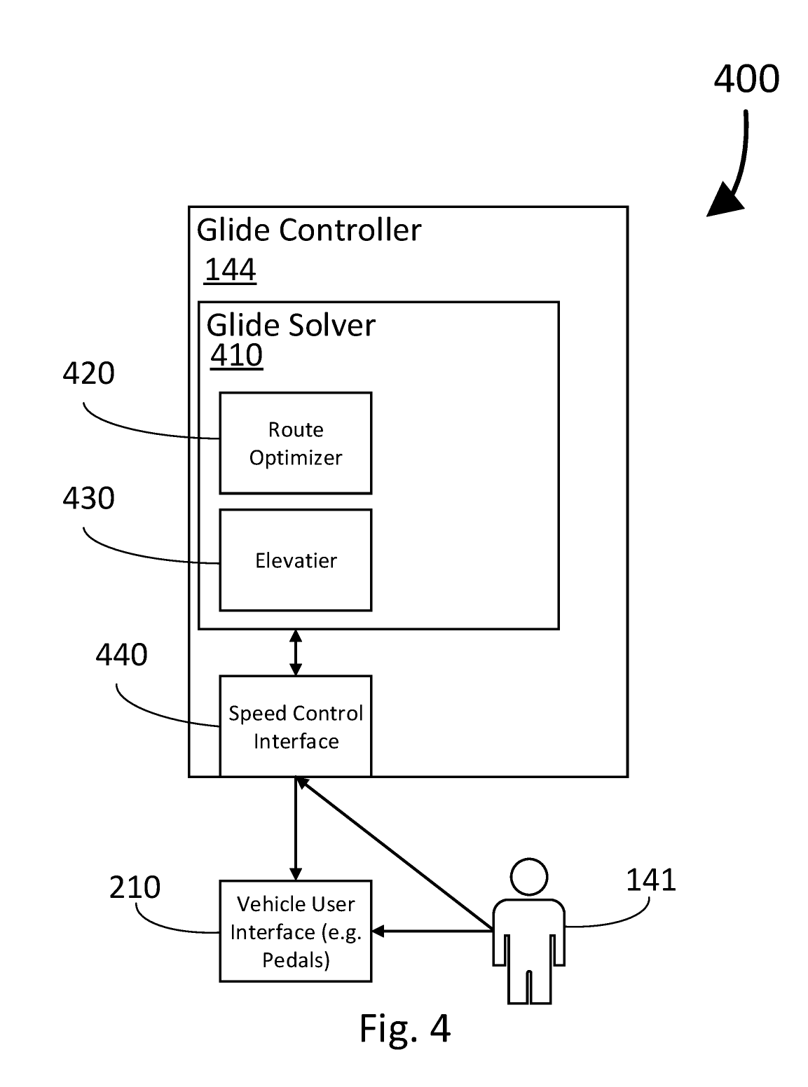

The Glide Controller 144 may physically connect to the vehicle's accelerator pedal 210. FIG. 4 shows the functional blocks for the Speed Control Interface 440 interacting with the vehicle's user interface (pedals) 210. In this way, the accelerator pedal 210 may be physically actuated by the Glide Controller 144 to adjust the acceleration of the vehicle to match the route optimization that the Glide Controller 144 has been tasked with carrying out.

The Glide Controller 144 may physically actuate the vehicle's accelerator pedal by using a vacuum servomotor that is driven by a microcontroller. In this way, the Glide Controller 144 may directly actuate the vehicle's accelerator pedal 210 through an electro-mechanical output. This is just an example of one way to interface with the vehicle's pedal and should not be considered an exclusive or limiting example.

The Glide Controller 144 may physically connect to the vehicle's throttle cable. It may connect to the cable that is physically connected to the accelerator pedal, or it may connect to the throttle cable controlled by the vehicle's cruise control system. In this way, the Glide Controller 144 may physically actuate the vehicle's accelerator cable, which will influence the vehicle's speed.

The Glide Controller's 144 Speed Control Interface 440 may actuate the throttle cable(s) via a vacuum servomotor and microcontroller, similar to the connection to the accelerator pedal that was just discussed. This is just an example of one way to interface with the throttle cable(s) and should not be considered an exclusive or limiting example.

The Speed Control Interface 440 may be responsible for processing the Glide Schedule received from the Glide Solver 410. This Glide Schedule may be a set of discretized points that pertain to locations along the requested route. These points may be the same optimization points that the Glide Solver 410 produces. The Speed Control Interface 440 may not be the only method for manipulating the performance of the vehicle. The Speed Control Interface 440 may also be responsible for producing Glide control messages. These control messages may be electronic and used to interface with the vehicular electronic communications.

In an embodiment where the Speed Control Interface 440 is not used to manipulate the vehicle, or the vehicular controls, a User 141 may be presented with instructions or a Glide Schedule. In this way, the Glide Schedule may be presented to the User 141 via instructions pertaining to how to operate the vehicle to adhere to the optimization produced by the Glide Controller 144.

This set of instructions (manual carrying out of the Glide Schedule) may be presented visually to the User 141 via the Glide User Interface 143, or the instructions may be presented audibly to the User 141, or the instructions may be presented via the vehicular GPS unit. The Glide Controller 144 should not be limited by these examples in how it may present instructions to the User 141.

The Speed Control Interface 440 may receive the Glide Schedule from a plurality of sources. In the embodiment where the Glide Controller 144 is present in the vehicle, the Speed Control Interface 440 may receive the Glide Schedule locally from the Glide Controller 144. In the embodiment where the Glide Controller 144 and its functionality is carried out remotely (non-locally—e.g., on the Glide Servers), the Speed Control Interface 440 may receive the Glide Schedule from a remote device (Glide Servers). These two examples serve to explain that the Glide Schedule may be received from a plurality of sources and does not server to exclude sources that may provide the Glide Schedule.

The Glide Schedule and Glide Schedule messages may be communicated via a plurality of methods. The messages may be communicated via one or multiple copper wire busses and protocols including but not limited to, UART, USART, I2C, EIA-232, CANbus, CANopen, and LIN. The messages may be communicated via one or multiple wireless communications protocols including but not limited to, cellular 3G, 4G and 4GLTE; WiFi; Bluetooth; and ZigBee. The Glide Schedule messages may also be communicated via an optical communications bus and protocol. These physical busses and messaging protocols serve as examples and should not serve as exclusive lists, but examples of possibilities.

The Glide control messages may be sent via the same busses and protocols listed above. Again, this does not serve as an exclusive list for how glide control messages may be communicated, but an example of possibilities.

While the example carried through in this description looks at manipulating the accelerator pedal of the vehicle, it should be noted that the Speed Control Interface 440 may manipulate a plurality of vehicle controls. These vehicular controls may include but are not limited to throttle (accelerator), brake, regenerative braking, de-acceleration, transmission controller, and power-train selection control. The Speed Control Interface 440 may receive Glide Schedules pertaining to the manipulation and control of any number of these or more vehicular controls. The Speed Control Interface 440 may produce any number of Glide control messages pertaining to and aimed at the control of any number of these or more vehicular controls. The Speed Controller 440 may manipulate multiple vehicular controls using multiple different methods (mechanical actuation and electronic control).

While FIG. 3 shows the Glide Controller 144 interfacing with the vehicle electrically (by the vehicle's electronics communications bus 360—e.g. CANbus), there are other electrical methods for the Glide Controller 144 to interact with the vehicular sensors 310, 320, 330, 340, 350, 360 and the electronic vehicular control unit (e.g. ECU) 142. The Speed Control Interface 440 may inject or send Glide control messages via the vehicular electronics communication bus 360 (e.g. CANbus).

### II. Glide Solver

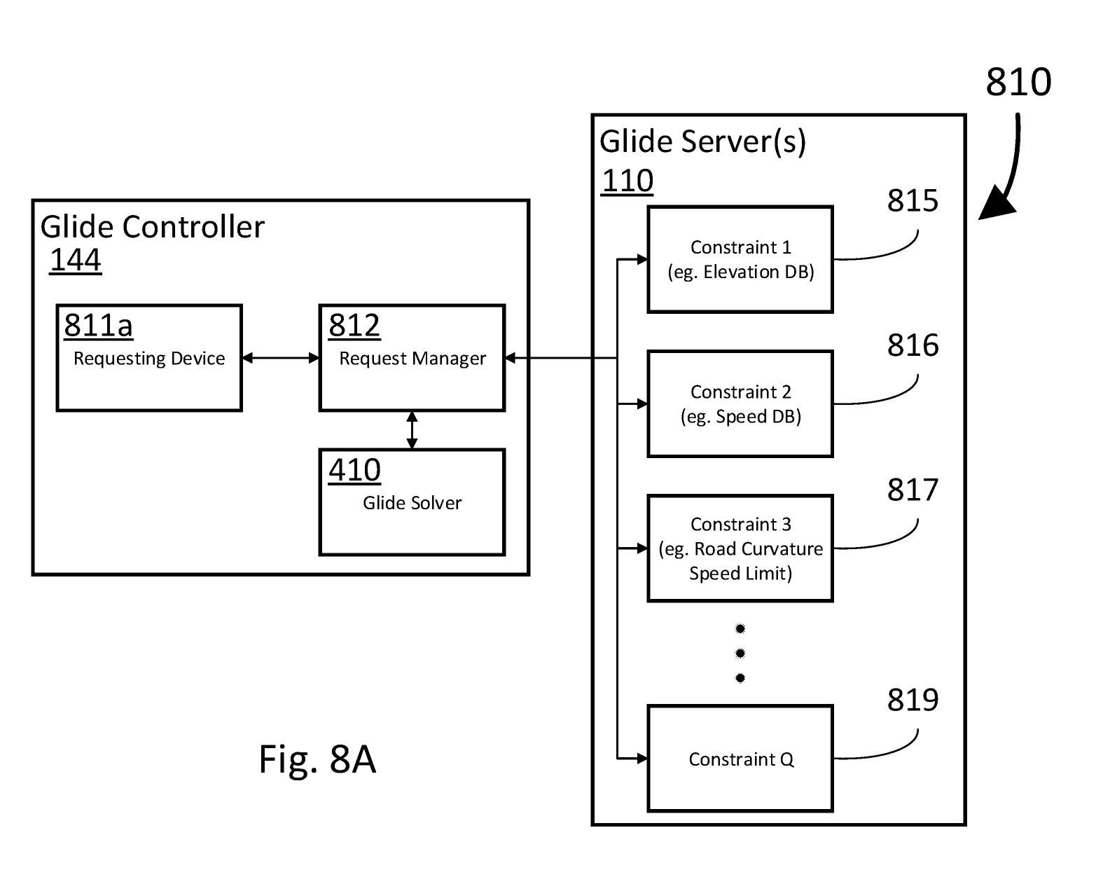

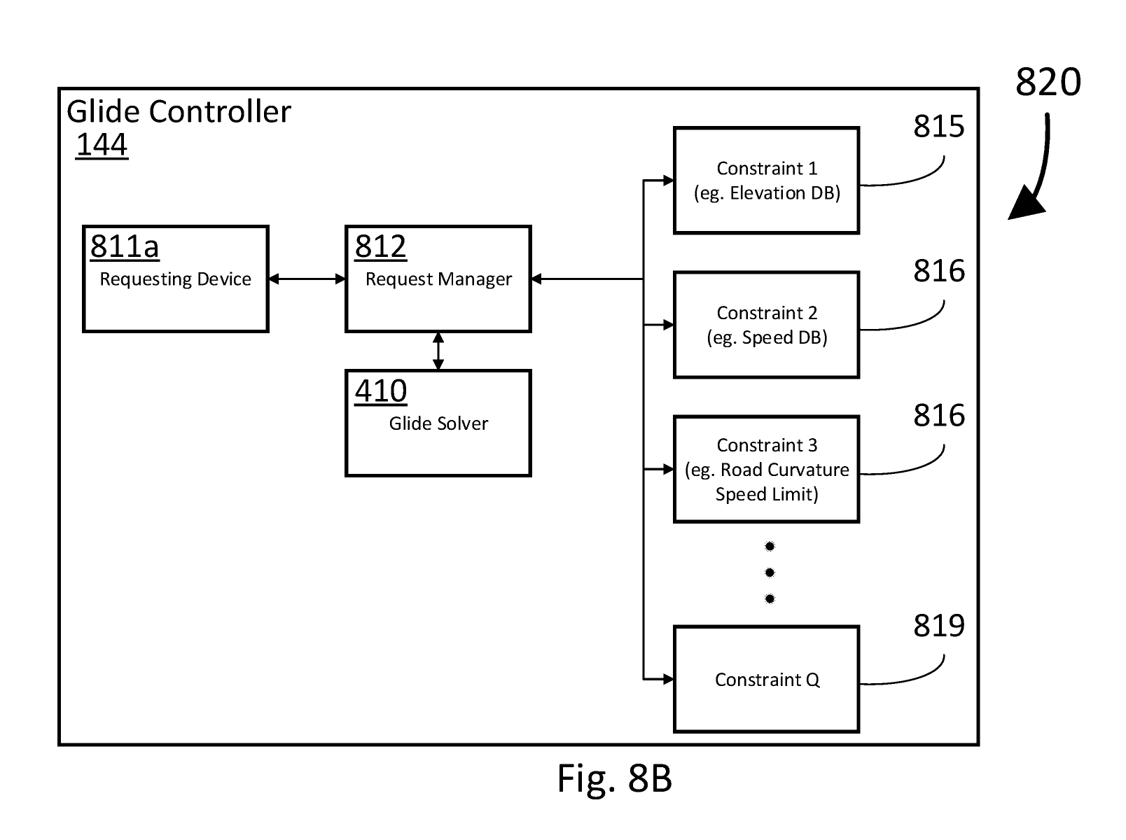

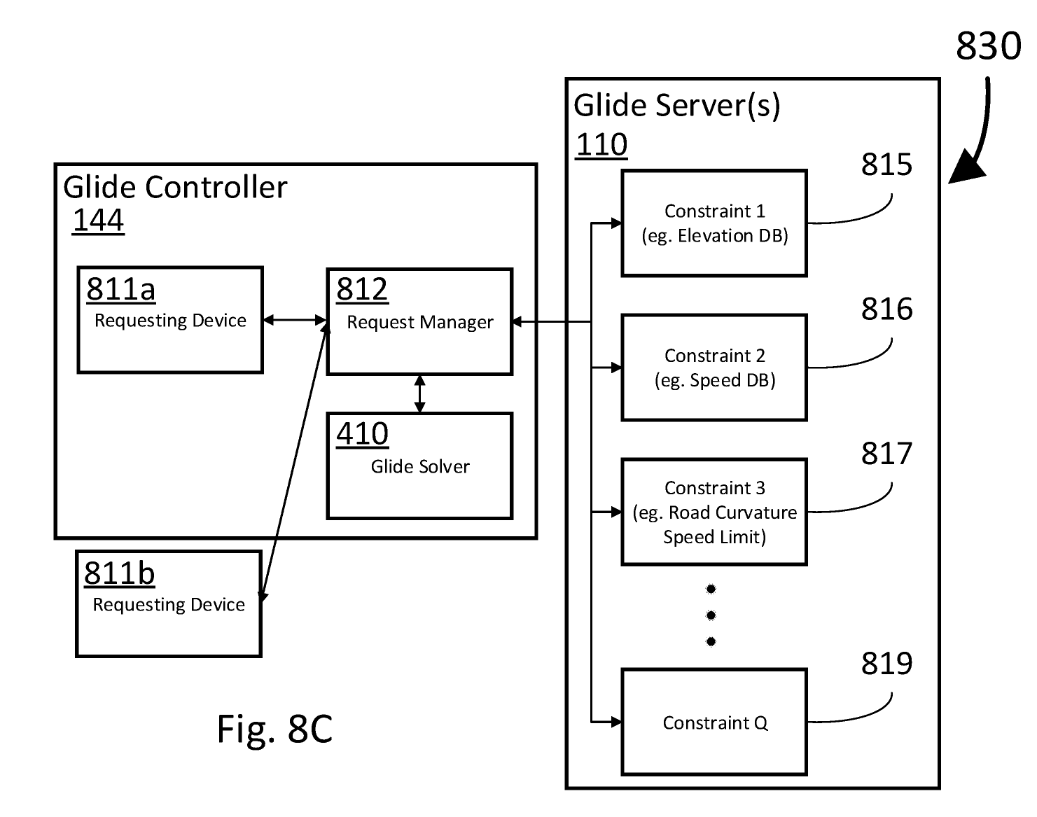

FIG. 8B shows one possible block diagram of the route processing side of the Glide System 100. The Requesting Device 811a may send a route request to the Request Manager 812. The requested route may be defined by start, end and waypoints; start and end; or simply start or end. The Requesting Device 811a may also define the route as GPS coordinates spaced at regular intervals along the route.

The Requesting Device 811a may be a User 141, an application (via a smartphone, table, or computer). The Requesting Device 811a may be the Glide User Interface 143. Additionally, the Requesting Device 811a could be the Glide WAN 120, if a User 141 is accessing a Glide Controller 144 via the Glide WAN 120.

In the standalone embodiment of the system, all of the blocks shown in FIG. 8B may be present in the Glide Controller 144 that is installed in the Glide enabled device 131, 132 . . . 139, 140, 150; in the connected embodiment, some, all, or none of these blocks may be present in Glide Controller 144 with the others present on the Glide Servers 110.

Returning to FIG. 8B, the request manager may then interact with both the Glide Solver 410 and the constraint databases 815, 816, 816 . . . 819 to provide the Glide Solver 410 with the information it needs to successfully complete the requested route optimization.

The constraint databases 815, 816, 817 . . . 819 may include information related to but not limited by, elevation, drag force, road speed, road curvature, road conditions, traffic, and weather. The Glide Solver 410 may request data from these databases to aid in the optimization of the requested route.

The constraint databases 815, 816, 817 . . . 819 may be stored on the Glide Servers 110, locally on the Glide Controller 144 or in other locations accessible via the Glide System WAN 120. Additionally, it may be possible to import constraint databases 815, 816, 817 . . . 819 into the Glide Controller 144. An example of this could be data pertaining to a foreign country. The constraint data may be read from a media storage device that is connected to the Glide Controller 144.

In addition to the constraint databases 815, 816, 817 . . . 819, the Glide Solver 410 and/or Request Manager 812 may request other information from the Glide Servers 110, 170, onboard memory or infrastructure servers.

Infrastructure servers and their databases may provide the information related but not limited to current traffic conditions, traffic light timing, current throughput, current throughput goals, current lane throughput, current lane throughput goals, traffic accidents, accident avoidance instructions, and emergency vehicle avoidance instructions.

Other Glide enabled vehicles 131, 132 . . . 139, 140 may be a source of additional information that the Glide Solver 410 or Request Manager 812 may request data from.

Since the breadth of information the Glide Solver 410 and Request Manager 812 has access to is large, the data resources are clearly not limited to those mentioned above.

Referring back to FIG. 8B, the Request Manager 812 receives a route from the Requesting Device 811a, and then requests the necessary constraint information from the constraint databases 815, 816, 817 . . . 819 for the requested route. The Request Manager 812 sends the constraint information and any route parameters provided by the Requesting Device 811a or other parameter sources to the Glide Solver 410.

The Glide Solver 410, shown in FIG. 4 as part of the Glide Controller 144, may include multiple algorithm blocks. Two of these blocks, shown in FIG. 4, may be the Route Optimizer 420 and the Elevatier 430.

The Route optimizer 420 may be used in all variations of the Glide System 100. As stated above, these may include, systems installed in vehicles, systems installed in transportation infrastructures, and systems operating in any of the modes discussed in this specification.

When installed in a vehicle, the Route Optimizer 420 may work by minimizing any number of parameter vectors of the vehicle from the starting point to the ending point of the route. The flow diagrams presented in the figure set use the positive direction acceleration vector as an example; this should not serve as a limiting or exclusive example. In minimizing this positive acceleration vector, the Glide Solver 410 minimizes the energy consumption necessary to complete the requested route. The Glide Solver 410 may minimize the norm-2 of the positive acceleration for each point along the route, or the Glide Solver 410 may minimize a piecewise linear function of the acceleration for each point along the route. The method for optimization should not be limited to the two previously mentioned methods. Any method of optimization may be applied in the Glide Solver 410. From these discrete acceleration points, the Glide Solver 410 may extrapolate and send discrete speeds that the vehicle should reach at predetermined points along the route to the Glide Controller 144 and Speed Control Interface 440.

The acceleration example carried through this discussion is just one of many parameters that the Glide Solver 410 and the Glide System 100 may optimize for. The discretized points that the Glide Solver 410 produces may be generally called a Glide Schedule. This Glide Schedule may include discretized points for any number of vehicle parameters. The Glide Schedule may pertain to but is not excluded by, acceleration, engine revolutions-per-minute (RPM), motor RPM, gear selection, powertrain selection, braking, and regeneration (regenerative braking).

The acceleration example carried throughout this description should not limit the scope of the parameters that the Glide Solver 410 or the Glide System 100 may solve for, but rather the example should illustrate how the Glide Solver 410 and Glide System 100 go about optimizing for a given parameter.

The Glide Solver 410 may minimize for multiple parameters. In this case, the Glide Solver 410 may minimize a weighted function of the multiple parameters.

In addition to minimizing the necessary energy for the route, the Glide Solver 410 may use user-configurable options and vehicle type to optimize for other route metrics including but not limited to, monetary cost, temporal trip duration, and travel time spent idle.

The monetary cost or a trip may include but is not limited to, vehicular operating cost, fuel cost, charging cost, and maintenance cost.

When installed in the transportation infrastructure, the Route optimizer 420 may work much in the same way. It may also optimize for other metrics including but not limited to, vehicle throughput, traffic latency and prioritization for special/emergency vehicles.

The Glide Schedule should not be thought of as a fixed solution. The Glide Controller 144 and Glide Solver 410 may continually adjust the Glide Schedule based on new or different data received. This data may be sensor data from one or more of the vehicular sensors, or this data may be received from the constraint databases 815,816,187 . . . 819. In this way, the Glide System 100 is continually working, optimizing, and adjusting the Glide Schedule

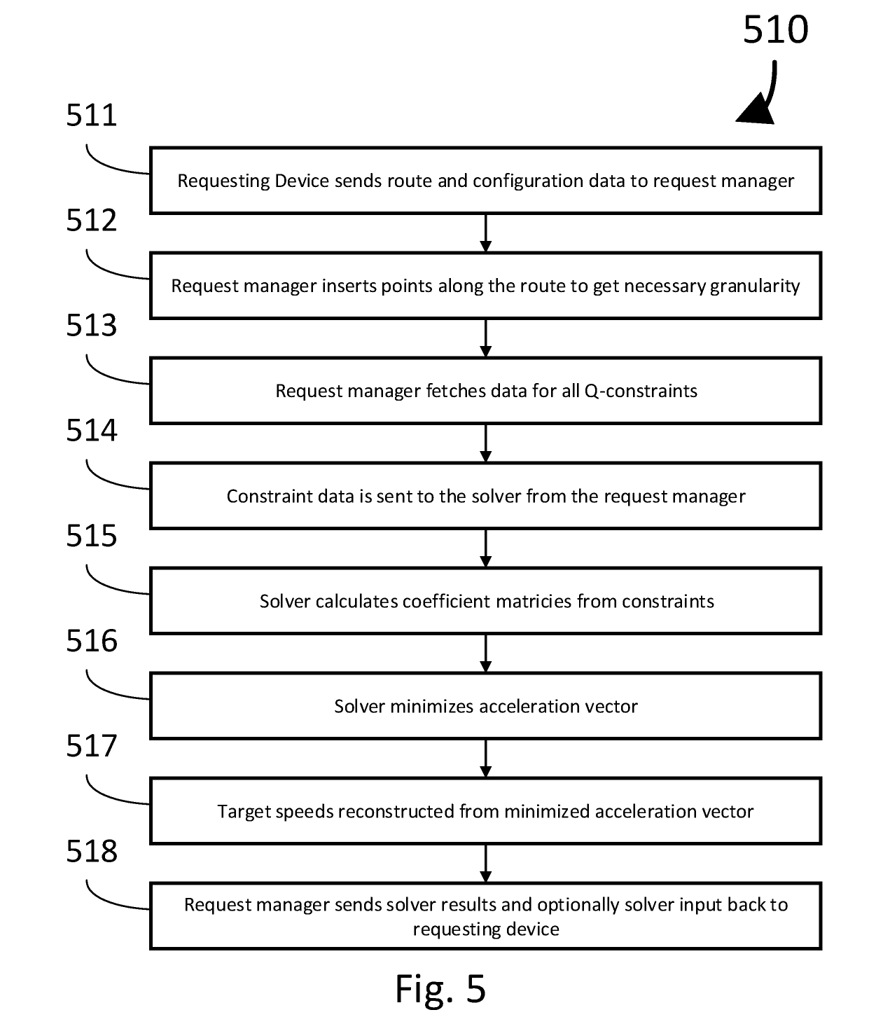

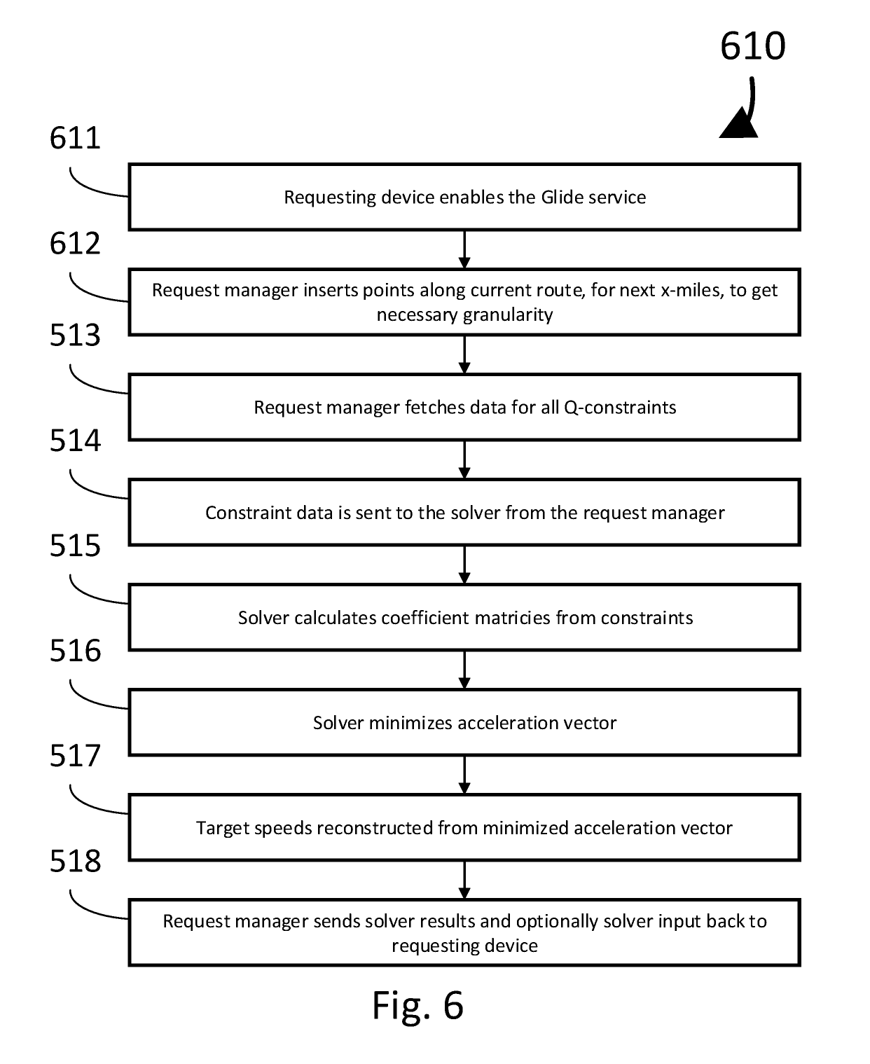

FIG. 5 and FIG. 6 show possible flow paths for the Glide System 100 from route request to route delivery. FIG. 5 shows a possible flow path for a Glide System 100 that is operating in the connected mode. This mode, as explained above, may denote that the Glide Controller 144 in the Glide enabled device 131, 132 . . . 139, 140, 150 is connected to the Glide Servers 110 via the WAN 120. FIG. 4B shows a possible flow path for a Glide System 100 that is operating without a final destination. This mode may denote that the Glide Controller 144 is simply looking a certain distance ahead of the current location and continually optimizing the route for the next x-miles.

Step 511 in FIG. 5 describes the Requesting Device 811a, 811b sending route information and configuration data to the Request Manager 812. The Requesting Device 811a, 811b may be any of a plethora of possible devices. In the simplest realization, the Requesting Device 811a, 811b may be a User 141. The User 141 may input the route and configuration data via a Glide User Interface 143.

The User 141 may be prompted for different pieces of information related to the route to be requested. These pieces of information could include but are not limited to, starting and ending points of the route; waypoints throughout the route; and parameters to be optimized for. The Glide Controller 144 may provide (via the Glide User Interface 143 suggestions to the User 141 based on past routes or even other Glide Users with similar habits or destinations.

The Glide Controller 144 may also predict the User's 144 routes and route preferences. An example of this may be predicting a route that is taken at 7:00 am every weekday morning with the starting point being the User's 141 home address, the ending point being the User's 141 work address and a waypoint at the local coffee shop. The Glide Controller 144 may predict this route and have the User's 141 typical preferences for this route auto-filled when the User 141 starts the system at 6:55 am.

The Glide User Interface 143 may refer generally to a module capable of providing the User 141 a way to provide route information and parameters into the Glide Controller 144. More specifically, the Glide User Interface 143 may be a visual feedback device with tactile or virtual buttons capable of reading data in and outputting data.

The Glide User Interface 143 may be a user's 141 cellular device, tablet or laptop computer. The Glide User Interface 143 may not necessarily be installed in the Glide enabled device 140, but may be a device that is connected via a wireless communications protocol and the Glide WAN 160 to the Glide Controller 144, the Glide enabled device 140, or the Glide WAN 120. In this way, the Glide Controller 144 may be controlled remotely (outside of the Glide enabled device 140). This Glide User Interface 143 may be any device capable of accepting information from a User 141. The Glide Use Interface 143 may include cellular phones, tablets, laptop computers or any other module capable of accepting inputs and communicating those inputs to the Request Manager 812.

In other realizations, the Requesting Device 811a, 811b may be a device similar to that of the Glide User Interface 143. A User's 141 cellular phone, tablet, or laptop may be more than just the Glide User Interface 143. The Requesting Device 811b may not necessarily be installed in the Glide enabled device 131, 132 . . . 139, 140, 150, or it may not be integrated into the Glide Controller 144. The Requesting Device 811a, 811b may be connected via a wireless communications protocol and the Glide WAN 160 to the Glide Controller 144 or directly to the Request Manager 812.

In other realizations or embodiments, the Requesting Device 811a, 811b may be the traffic infrastructure 150, or the Glide Servers 110.

Referring back to FIG. 5, step 511, the Requesting Device 811a, 811b (discussed above) may send the route configuration data to the Request Manager 812. The route information from the Requesting Device 811a, 811b may be defined in a plurality of manners.

The route information may be sent as a set of locations, starting, ending and waypoints in between; starting and ending; simply starting or simply ending. The route information may also be sent as a list of GPS points spaced along the desired route.

Step 512 of FIG. 5 describes the Request Manager 812 inserting points along the route to gain the necessary granularity to accurately optimize the route. The purpose of this step is to create more data points for the Glide Solver 410 to calculate. More data points along the route means the Glide Solver 410 will be able to solve for more acceleration points, and this means the speed targets will have finer resolution.

In step 512 of FIG. 5, the Request Manager 812 may or may not insert additional points along the route. If the route data from step 511 was provided as a list of GPS points, and the Request Manager 812 determines the GPS points provide an adequate level of resolution (granularity), step 512 may not be carried out.

Step 512 in FIG. 5 should not be limited to just the Request Manager 812. In some embodiments of the Glide System 100, the data insertion may be carried out by another functional block (e.g. the Glide Solver 410).

In step 513 in FIG. 5, the Request Manager 812 may fetch the necessary data from the constraint databases 815, 816, 817 . . . 819. The constraint databases 815, 816, 817 . . . 819 may include information related to but not limited by, elevation, road speed, and road curvature. The Request Manager 812 may request data from the constraint databases 815, 816, 817 . . . 819 for each point along the requested route. These points may be the points created in step 512, or they may be points provided by the Requesting Device 811a, 811b.

The constraint databases 815, 816, 817 . . . 819 may be stored on the Glide Servers 110, locally on the Glide Controller 144, or in other locations accessible via the Glide System WAN 120. Additionally, it may be possible to import constraint databases 815, 816, 817 . . . 819 into the Glide Controller 144. The constraint data may also be read in from a media storage device that is connected to the local Glide Controller 144.

In addition to the constraint databases 815, 816, 817 . . . 819, the Glide Solver 410 and/or Request Manager 812 may request other information from the Glide Servers 110, 170, onboard memory or infrastructure servers.

Infrastructure servers and their databases may provide the information related but not limited to current traffic conditions, traffic light timing, current throughput, current throughput goals, current lane throughput, current lane throughput goals, traffic accidents, accident avoidance instructions, and emergency vehicle avoidance instructions.

The Request Manager 812 may request data points from all necessary constraint data bases 815, 816, 817 . . . 819 and other data sources for all points along the request route. The Request Manager 812 may request data in parallel from all or some of the necessary constraint databases 815, 816, 817 . . . 819 and other data sources, or the Request Manager 812 may queue the data requests. If the Request Manager 812 queues the data requests, only one constraint database 815, 816, 817 . . . 819 may be queried at a time.

Other Glide enabled vehicles 131, 132 . . . 139, 140 may also be a source of additional information that the Request Manager 812 may request data from.

In step 514 in FIG. 5, the constraint data collected by the Request Manager 812 from the constraint databases 815, 816, 817 . . . 819 and other data sources may be sent to the Glide Solver 410. The Request Manager 812 may also send the route information, parameters and preferences that it received from the Requesting Device 811a, 811b to the Glide Solver 410.

The Glide Solver 410 may receive all of the data pertaining to the route from the Request Manager 812 at once (in bulk), or the Glide Solver 410 may receive all of the data from the Request Manager 812 in a stream as the Request Manager 812 requests the data from the constraint databases 815, 816, 817 . . . 819.

In step 515 in FIG. 5, the Glide Solver 410 may use the data it received in step 514 from the Request Manager 812 to calculate the coefficient matrices of the constraints.

In step 516 in FIG. 5, the Glide Solver 410 may use the coefficient matrices constructed in step 515 to minimize the acceleration vector. The Glide Solver 410 may be an inequality constrained norm-2 solver that uses the coefficients calculated in step 515 to minimize the norm-2 of the acceleration for each point along the route.

The norm-2 solver referenced above is depicted in FIG. 4. With reference to FIG. 4, the Glide Solver 410, may include multiple algorithm blocks 420, 430. One of these blocks may be an Route optimizer 420. This Route optimizer 420 may be the norm-2 solver referenced above. The acceleration vector that is being minimized is proportional to the energy vector. Minimizing the acceleration vector corresponds to minimizing the energy vector.

Included as part of step 516 in FIG. 5 may be the Glide Solver 410 producing a set of acceleration points that constitute the solution to the minimized acceleration vector.

In step 517 in FIG. 5, the Glide Solver 410 may use the set of acceleration points created in step 516 to create a set of speed points along the route. This set of speeds along the route may serve as targets for the Glide Controller 410 to aim for as the vehicle progresses through the route.

The target speed points along the route may be calculated via the minimized acceleration vector and any other factors that are vehicle, road or driver specific that might influence the movement of the vehicle. Two examples of factors that may be taken into account when the Glide Solver 410 creates the set of target speed points are the vehicle's drag coefficient as well as any load the vehicle might be carrying or pulling.

In step 518 in FIG. 5, the Request Manager 812 may receive the route results from the Glide Solver 410, and the Request Manager 812 may send the Glide Solver's 410 results to the Requesting Device 811a, 811b. The Request Manager 812 may also send the inputs used for the Glide Solver 410.

If applicable, the Requesting Device 811a, 811b may display the results from the Glide Solver 410 on the Glide User Interface 143. The Glide User Interface 143 may display information related but not limited to, estimated trip duration; estimated trip cost; estimated time spent moving versus idle or in traffic; total estimated energy consumption; and estimated refueling/recharging locations.

Additionally, the User 141 may be able to view the results from the Glide Solver 410 and make changes to any of the input parameters that were previously provided. If the User 141 makes changes to the proposed route/trip, the Glide Request Manager 812 and Glide Solver 410 may recalculate the proposed route/trip with the new preferences or parameters proposed by the User 141. The Request Manager 812 and Glide Solver 410 may return the edited results to the Requesting Device 811a, 811b and the Glide User Interface 143. The new results may be displayed along with the previous results for the User 141 to compare.

It may follow that the User 141 could input a range of route/trip parameters and preferences and the Request Manager 812 and Glide Solver 410 may return multiple different routes for the User 141 to pick from. In this way, the User 141 may be able to see how different parameters affect the results of the trip optimization.

The flow diagram in FIG. 5 should not serve as an exclusive method for the Glide System 100 to complete a route request and optimization. FIG. 5 merely serves as an example for one possible way for the Glide System 100 to fulfill a route request.

FIG. 6 shows a flow diagram for another possible mode of operation for the Glide System 100. In FIG. 5, the flow diagram depicted the possible steps the Glide System 100 may take when given route parameters. These route parameters may include starting, ending, and waypoint destinations. The flow diagram in FIG. 6 shows possible steps for the Glide System 100 operating without and final destination.

In another mode, the User 141 may simply enable the Glide Controller 144 in a Glide enabled device 131, 132 . . . 139, 140, 150. In doing this, the Glide Controller 144 may look ahead for the next x-miles along the current route and optimize the route for the next x-miles. This is a functionally different mode from the previous example in that the end point is continuously moving. The Glide Controller 144 may continuously look ahead for the next x-miles, so the Glide Controller 144 is constantly updating its “end” destination.

In step 611 in FIG. 6, the Requesting Device 811a, 811b may enable the Glide Controller 144. The Requesting Device 811a, 811b may be any of a plethora of possible devices. In the simplest realization, the Requesting Device 811b may be a User 141. The User 141 may enable the Glide Controller 144 via the Glide User Interface 143.

The Glide User Interface 143 may refer generally to a module capable of providing the User 141 a way to enable the Glide Controller 144. In other modes of operation, the Glide User Interface 143 may refer generally to a module capable of providing the User 141 a way to provide route information and parameters into the Glide Controller 144. More specifically, for all modes of operation, the Glide User Interface 143 may be a visual feedback device with tactile or virtual buttons capable of reading data in and outputting data to and from the Glide Controller 144.

The Glide User Interface 143 may be a user's 141 cellular device, tablet or laptop computer. The Glide User Interface 143 may not necessarily be installed in the Glide enabled device 140, but may be a device that is connected via a wireless communications protocol and the Glide WAN 160 to the Glide Controller 144, the Glide enabled device 140, or the Glide WAN 120. In this way, the Glide Controller 144 may be controlled remotely (outside of the Glide enabled device 140). This Glide User Interface 143 may be any device capable of accepting information from a User 141. The Glide Use Interface 143 may include cellular phones, tablets, laptop computers or any other module capable of accepting inputs and communicating those inputs to the Request Manager 812.

In other realizations, the Requesting Device 811a, 811b may be a device similar to that of the Glide User Interface 143. A User's 141 cellular phone, table, or laptop may be more than just the Glide User Interface 143. The requesting Device 811b may not necessarily be installed in the Glide enabled device 131, 132 . . . 139, 140, 150, or it may not be integrated into the Glide Controller 144. The Requesting Device 811a, 811b may be connected via a wireless communications protocol and the Glide WAN 160 to the Glide Controller 144 or directly to the Request Manager 812.

In other realizations or embodiments, the Requesting Device 811a, 811b may be the traffic infrastructure 150, or the Glide Servers 110.

Referring back to FIG. 6, step 611, the Requesting Device 811a, 811b (discussed above) may enabled the Glide Controller 144. In the connected embodiment, this may enabled the Glide Service 100 as well.

The User 141 may be able to use a quick select menu to choose parameters that the Glide Controller 144 and Glide Solver 410 should optimize for. An example of this could be: the User 141 enables the Glide Controller 144 and uses the quick select menu on the Glide User Interface 143 to tell the Glide Controller 144 to optimize for time. The Glide Controller 144 may then continuously optimize the next x-miles ahead of the current position for time.

In step 612 in FIG. 6, the Request Manager 812 may insert points along the route for the next x-miles in order to create the granularity necessary to accurately optimize the next x-miles along the current route. The purpose of this step is to create more data points for the Glide Solver 410 to calculate. More data points along the route means the Glide Solver 410 will be able to solve for more acceleration points, and this means the speed targets will have finer resolution.

Step 612 in FIG. 6 should not be limited to just the Request Manager 812. In some embodiments of the Glide System 100, the data insertion may be carried out by another functional block (e.g. the Glide Solver 410).

In step 513 in FIG. 6, the Request Manager 812 may fetch the necessary data from the constraint databases 815, 816, 817 . . . 819. The constraint databases 815, 816, 817 . . . 819 may include information related to but not limited by, elevation, road speed, and road curvature. The Request Manager 812 may request data from the constraint databases 815, 816, 817 . . . 819 for each point along the requested route. These points may be the points created in step 512, or they may be points provided by the Requesting Device 811a, 811b.

The constraint databases 815, 816, 817 . . . 819 may be stored on the Glide Servers 110, locally on the Glide Controller 144, or in other locations accessible via the Glide System WAN 120. Additionally, it may be possible to import constraint databases 815, 816, 817 . . . 819 into the Glide Controller 144. The constraint data may also be read in from a media storage device that is connected to the local Glide Controller 144.

In addition to the constraint databases 815, 816, 817 . . . 819, the Glide Solver 410 and/or Request Manager 812 may request other information from the Glide Servers 110, 170, onboard memory or infrastructure servers.

Infrastructure servers and their databases may provide the information related but not limited to current traffic conditions, traffic light timing, current throughput, current throughput goals, current lane throughput, current lane throughput goals, traffic accidents, accident avoidance instructions, and emergency vehicle avoidance instructions.

The Request Manager 812 may request data points from all necessary constraint data bases 815, 816, 817 . . . 819 and other data sources for all points along the request route. The Request Manager 812 may request data in parallel from all or some of the necessary constraint databases 815, 816, 817 . . . 819 and other data sources, or the Request Manager 812 may queue the data requests. If the Request Manager 812 queues the data requests, only one constraint database 815, 816, 817 . . . 819 may be queried at a time.

Other Glide enabled vehicles 131, 132 . . . 139, 140 may also be a source of additional information that the Request Manager 812 may request data from.

In step 514 in FIG. 6, the constraint data collected by the Request Manager 812 from the constraint databases 815, 816, 817 . . . 819 and other data sources may be sent to the Glide Solver 410. The Request Manager 812 may also send the route information, parameters and preferences that it received from the Requesting Device 811a, 811b to the Glide Solver 410.

The Glide Solver 410 may receive all of the data pertaining to the route from the Request Manager 812 at once (in bulk), or the Glide Solver 410 may receive all of the data from the Request Manager 812 in a stream as the Request Manager 812 requests the data from the constraint databases 815, 816, 817 . . . 819.

In step 515 in FIG. 6, the Glide Solver 410 may use the data it received in step 514 from the Request Manager 812 to calculate the coefficient matrices of the constraints.

In step 516 in FIG. 6, the Glide Solver 410 may use the coefficient matrices constructed in step 515 to minimize the acceleration vector. The Glide Solver 410 may be an inequality constrained norm-2 solver that uses the coefficients calculated in step 515 to minimize the norm-2 of the acceleration for each point along the route for the next x-miles along the current route.

The norm-2 solver referenced above is depicted in FIG. 4. With reference to FIG. 4, the Glide Solver 410, may include multiple algorithm blocks 420, 430. One of these blocks may be an Route optimizer 420. This Route optimizer 420 may be the norm-2 solver referenced above. The acceleration vector that is being minimized is proportional to the energy vector. Minimizing the acceleration vector corresponds to minimizing the energy vector.

Included as part of step 516 in FIG. 6 may be the Glide Solver 410 producing a set of acceleration points that constitute the solution to the minimized acceleration vector.

In step 517 in FIG. 6, the Glide Solver 410 may use the set of acceleration points created in step 516 to create a set of speed points along the route for the next x-miles along the current route. This set of speeds along the route may serve as targets for the Glide Controller 410 to aim for as the vehicle progresses through the next x-miles of the route.

The target speed points along the route for the next x-miles may be calculated via the minimized acceleration vector and any other factors that are vehicle, road or driver specific that might influence the movement of the vehicle. Two examples of factors that may be taken into account when the Glide Solver 410 creates the set of target speed points are the vehicle's drag coefficient as well as any load the vehicle might be carrying or pulling.

In step 518 in FIG. 6, the Request Manager 812 may receive the route results from the Glide Solver 410, and the Request Manager 812 may send the Glide Solver's 410 results to the Requesting Device 811a, 811b. The Request Manager 812 may also send the inputs used for the Glide Solver 410.

It should be noted that the Glide Solver 410 may provide multiple different routes for the same starting and ending destinations. These multiple different routes may be displayed to the User 141, and the User 141 may be able to choose the preferred route. In addition to providing multiple routes, the Glide Solver 410 may provide estimations for time of arrival, energy usage, and necessary refueling or recharging. The estimations or additional information provided by the Glide Solver 410 should not be limited to the above listed data.

In other embodiments, third party routing services may be used to provide the multiple different routes. In this embodiment, the Glide Solver 410 may then be applied to the multiple different routes provided by the third party routing services.

If applicable, the Requesting Device 811a, 811b may display the results from the Glide Solver 410 on the Glide User Interface 143. The Glide User Interface 143 may display information related but not limited to, estimated running cost since the Glide Controller 144 has been enabled; estimated and running totals of time spent moving versus idle or in traffic; total estimated energy consumption since the Glide Controller 144 has been enabled; and estimated refueling/recharging locations based on the needs of the vehicle for the next x-miles of the route.

Additionally, the User 141 may be able to view the results from the Glide Solver 410 and make changes to the quick select optimization selections that were originally made. If the User 141 makes changes to the quick select optimization selections, the Glide Request Manager 812 and Glide Solver 410 may recalculate the next x-miles of the current route with the new quick select selections provided by the User 141. The Request Manager 812 and Glide Solver 410 may return the edited results to the Requesting Device 811a, 811b and the Glide User Interface 143. The new results may be displayed along with the previous results for the User 141 to compare. Ultimately, the User 141 may be asked to select from one of the possible optimizations of the next x-miles, or the Glide Controller 144 may default to a preset optimization setting for the next x-miles if one is not chosen.

The flow diagram in FIG. 6 should not serve as an exclusive method for the Glide System 100 to complete a route optimization for the next x-miles of the current route. FIG. 6 merely serves as an example for one possible way for the Glide System 100 to fulfill a request to optimize the next x-miles of the current route.

### III. Elevatier (Elevation Finder)

FIG. 4 shows a possible functional block for the Glide Controller 144 and Glide Solver 410. The Glide Solver 410 may include specific algorithms designed to complete tasks in the Glide System 100. The Elevatier 430 may be one of these algorithms.

The Elevatier 430 may describe an algorithm specifically designed for finding a point of data (related geographically) from a very large database of information. While not limiting the scope of application for this algorithm, the Glide System 100 may use this algorithm for quickly finding data related to elevation along the requested route. The general algorithm used in the Elevatier 430 may be applied to any rapid search function tasked with querying large databases for data points.

The index and indexing algorithm used by the Elevatier 430 may include any of a wide range of algorithms and indexing methods. Specifically, an rtree indexing scheme and data structure may be used to organize data. It may also follow that an rtree spatial indexing algorithm may be used by the Elevatier 430 to search a database. The spatial data structure index and the spatial indexing algorithm should not be limited to one of an rtree nature; the rtree example serves only to show one possibility for the structure and algorithm.

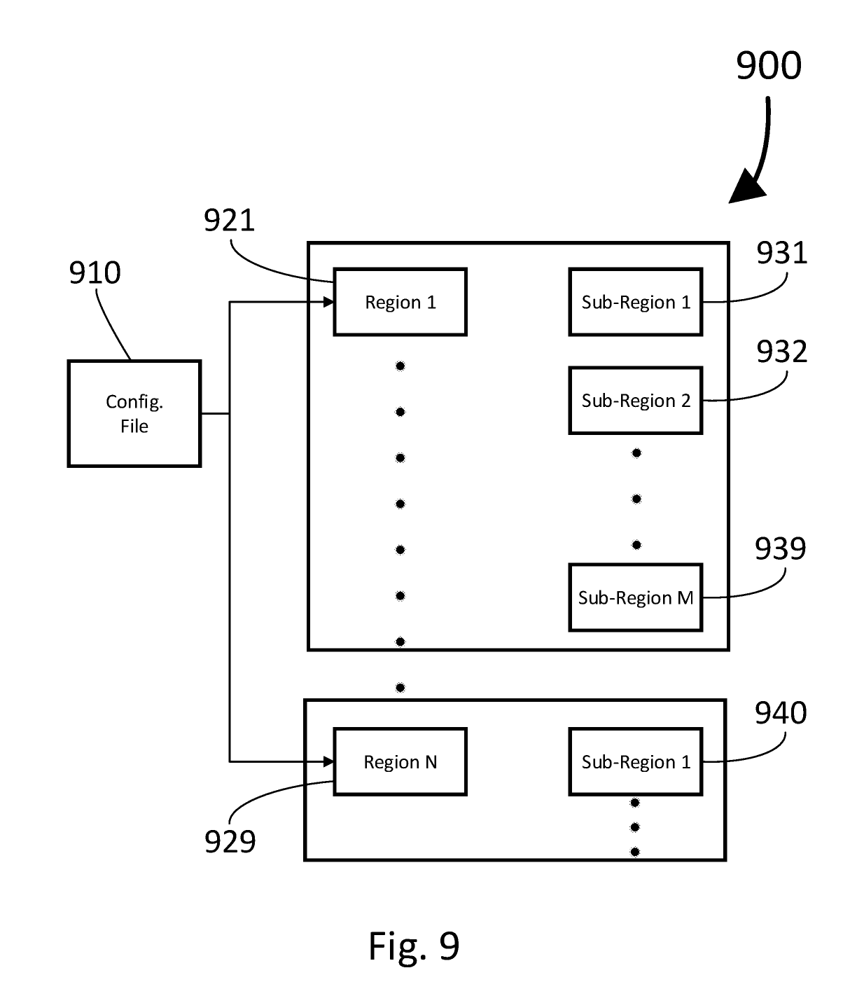

FIG. 9 shows how elevation data may be organized to allow for the Elevatier 430 to quickly extract data need by the Glide Solver 410. The configuration file 910 for the given data may be broken into N regions 921 . . . 929. An example of the regional level 921 . . . 929 could be sections of the continental United States (west, central, and east). These regions may then be broken down into sub-regions 931, 932 . . . 939, 940. An example of this could be states within the larger region (Washington, Oregon, California, Arizona, Nevada and Idaho could be in the west region). FIG. 9 depicts two levels of data (regions 921 . . . 929 and sub-regions 931, 932 . . . 939, 940), but data organization should not be limited to two levels. Data organization levels may extend as many levels as necessary. To continue with the above example, the next layer could be regions within each state, then counties within each region, then cities within each county.

All files for a given region may be stored in the same directory, and they may be indexed spatially. This may hold true for any region 921 . . . 929 or sub-region 931, 932 . . . 939, 940 level in the data organization scheme. Organization may include regions 921 . . . 929 and sub-regions 931,932 . . . 939,940 being stored in the same hierarchical level. The regions 921 . . . 929 and sub-regions 931, 932 . . . 939, 940 may also not be hierarchical.

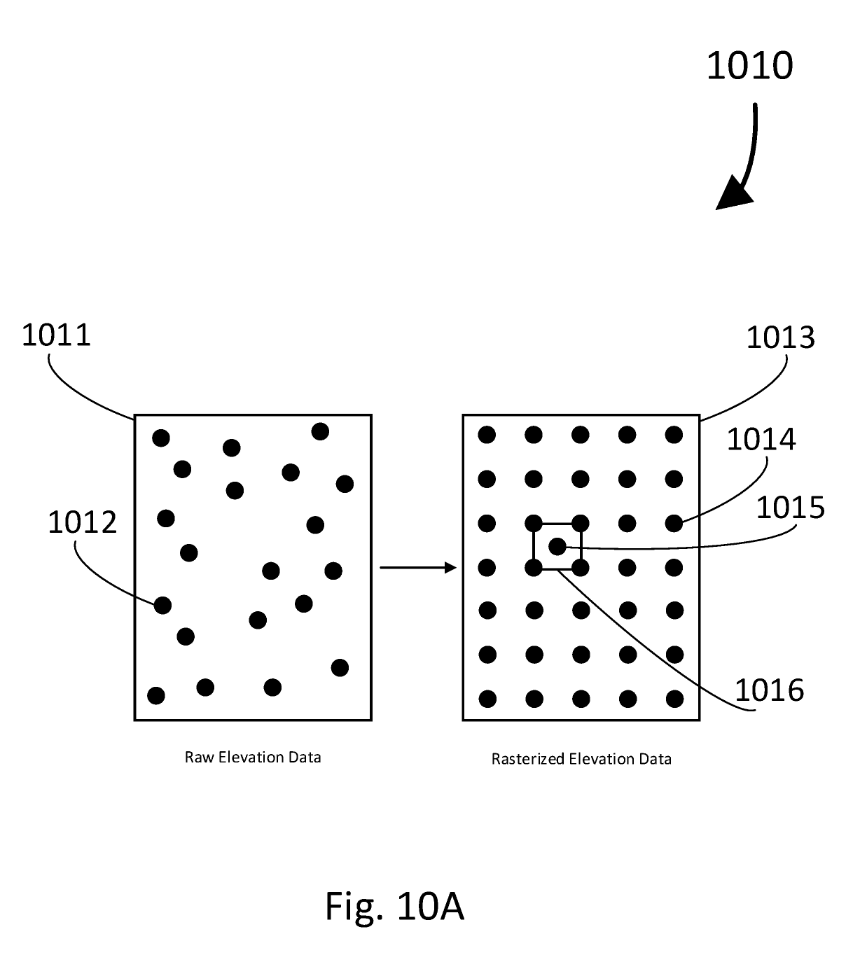

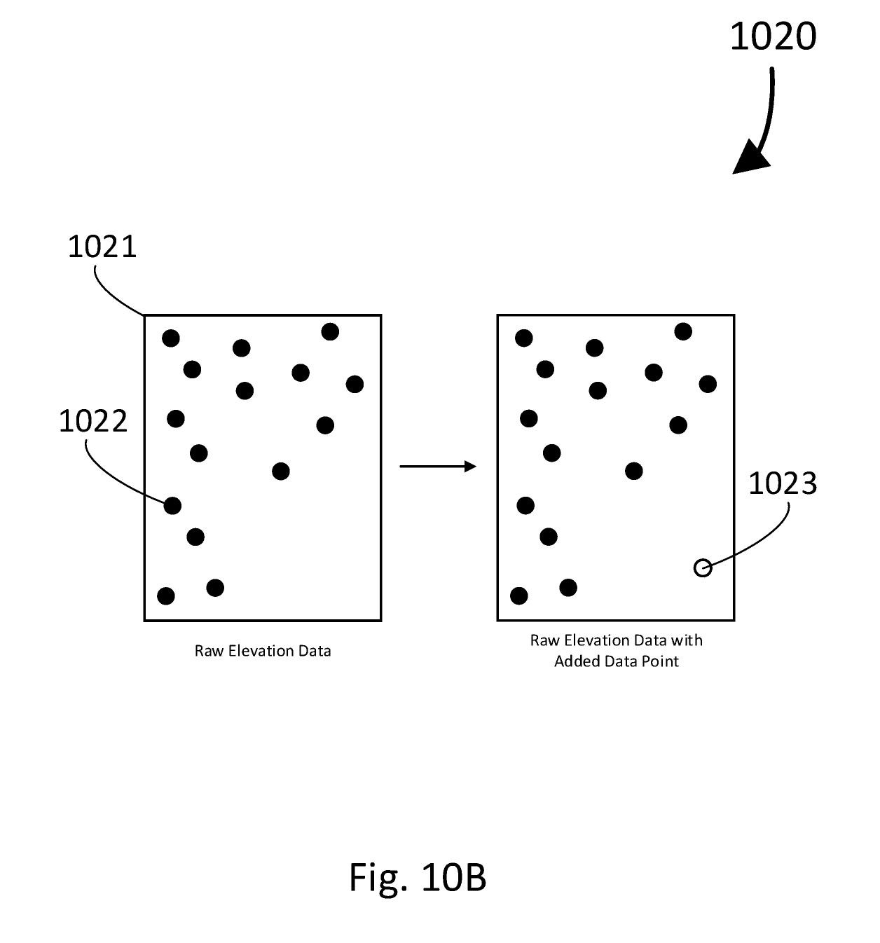

FIG. 10A shows how data may be manipulated between the raw data 1011 stored in memory (be it local or on a server) and the data that is accessed 1013 for delivery to the Request Manager 812 and eventually the Glide Solver 410.

Before the data point(s) 1014 being requested are found in the data base 1013, the Elevatier 430 algorithm may rasterize the raw elevation data 1012 to produce and even spaced matrix 1013 of data points 1014. FIG. 10A shows the matrix 1011 of un-rasterized (raw) data points 1012. The Elevatier 430 algorithm may rasterized the raw data 1012 to produce a rasterized matrix 1013 of the rasterized data points 1014.

The Request Manager 812 may request a data point that already exists in the elevation database. If this is the case, the Elevatier 430 algorithm may simply rasterize the data and select the data point 1014 from the rasterized matrix 1013.

If the Request Manager 812 requests a data point that is not already in the elevation database, the Elevatier 430 may have to extrapolate the data point from the existing points in the database.

There may be a functional block, included with the Elevatier that is an elevation request manager for the Elevatier. This elevation request manager may be different from the Request Manager 812. While the Request Manager 812 may handle data between the Elevatier 430, constraint databases 815, 816, 817 . . . 819, the Glide Solver 410, and the Requesting Device 811a, 811b, the elevation request manager may be a front end function of the Elevatier 430 that may handle incoming data point requests.

To obtain the extrapolated point 1015, that the Request Manager 812 has requested, a polygon 1016 may be created around the requested point 1015. The points that make up the polygon vertices may include the polygon vertices' locations as well as the elevation information at the polygon points. The point of interest 1015 (the queried elevation point) may then be extrapolated from the points surrounding it (the vertices of the polygon).

FIG. 10A serves only to illustrate how a data point that is not already in the database may be extrapolated from surrounding data points. It should in no way serve as a limiting or exclusive situation. For example, the polygon formed by already existing, surrounding data points may be a hexagon or other polygon.

In addition to querying data points, the Elevatier 430 algorithm may also add points 1023 to the existing databases. FIG. 10B shows the un-rasterized (raw) data matrix 1021 including the raw data points 1022. FIG. 10B also shows a new data point 1023 may be added to the existing data set. In this way, the Glide System 100 may take data collected from Glide enabled devices 131, 132 . . . 139, 140, 150 and increase the size and accuracy of the Glide databases with this gathered information.

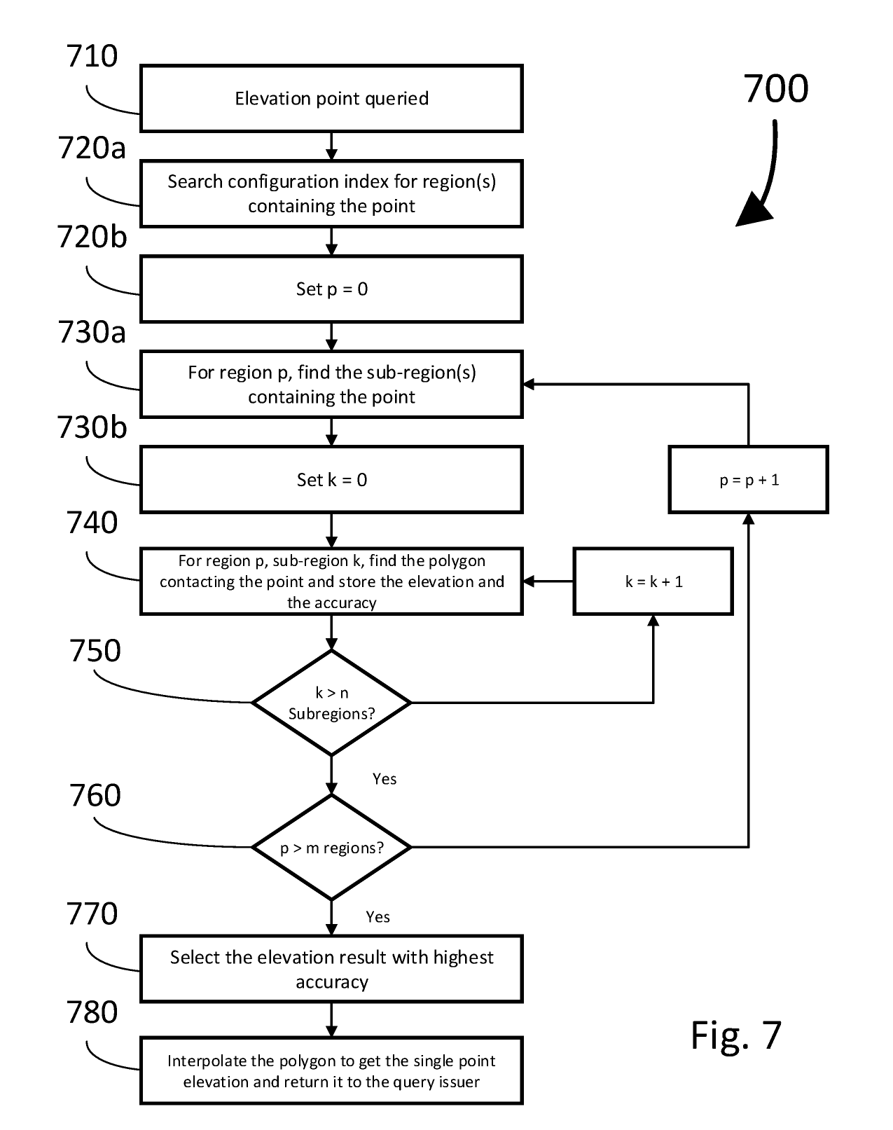

FIG. 7 shows a possible flow path for the Elevatier 430 algorithm. FIG. 7 should in no way serve as a limiting or exclusive flow path; its purpose is simply to illustrate how a database querying algorithm like the Elevatier 430 could work.

In step 710 in FIG. 7, an elevation point may be queried by the Request Manager 812. This requested data point could correspond to the geographic location of one of the route points created in step 512 or 612 in FIG. 5 and FIG. 6, respectively.

In step 720a, the Elevatier 430 algorithm may search the configuration file 910 for the region(s) 921 . . . 929 that include the queried point.

To complete step 720a, the Elevatier 430 algorithm will cycle through two nested loops. The first loop may cycle through the regions 921 . . . 929, and the second loop may cycle through the sub-regions 931, 932 . . . 939, 940.

In step 720b in FIG. 7, the region counter may be set to 0. Step 730a may enter the second nested loop of the Elevatier 430 algorithm. The initial condition of the second nested loop is to set the sub-region counter to 0 730b.

In step 740 in FIG. 7, the polygon contacting the queried point in a particular region and sub-region is stored. The information stored during this step may include but is not limited to the elevation data and the accuracy associated with the elevation data.

Steps 750 and 760 in FIG. 7 may serve as loop checks to allow the Elevatier 430 algorithm to decide when to exit one of the loops. The loop indexes may be positively index each loop iteration to cycle through all sub-regions 931, 932 . . . 939 and all regions 921 . . . 929.

In step 770 in FIG. 7, all of the elevation points stored from step 740 may be compared, and the one(s) with the highest accuracy are saved.

In step 780 in FIG. 7, the polygon 1016 surrounding the point of interest 1015 may be formed, and the single point of interest 1015 can be extrapolated from the polygon 1016.

### IV. Glide Controller Variations

A Glide Controller 144 may have different configurations within the Glide System 100. Three possible variations will now be discussed. These three variations should in no way limit the variation possibilities of the Glide Controller 144 within or outside of the Glide System 100.

FIG. 8A depicts one possible variation of the Glide Controller 144 within the Glide System 100. In FIG. 8A, the Glide Controller 144 may include multiple modules. These modules may include the Requesting Device 811a, the Request Manager 812 and the Glide Solver 410. In this configuration, the Glide Controller 144 is also the Requesting Device 811a.

In FIG. 8A, the Requesting Device 811a is shown as a sub component of the Glide Controller 144. In this way, the Glide Controller 144 may be receiving the requested route from the internal Requesting Device 811a. An example of this situation may include the Glide Controller 144 optimizing for the next x-miles, without receiving an ending destination.

In FIG. 8A, the Request Manager 812 and Glide Solver 410 are hosted locally on the Glide Controller 144. This means that computation carried out by the Route Optimizer 420 and the Elevatier 430 may occur locally on the Glide Controller 144.

In FIG. 8A, the constraint databases 815, 816, 817 . . . 819 are shown as existing on the Glide Servers 110. It would follow that in this configuration, the Glide Controller 144 would be operating in the “connected”, subscription-based mode, where a User 141 may pay a temporally regular fee for regular communication 160 with the Glide Servers 110.

FIG. 8B depicts another possible variation of the Glide Controller 144 within the Glide System 100. In FIG. 8B, the Glide Controller may include all of the functional blocks that have been previously discussed. This would include the Requesting Device 811a, the Request Manager 812, the Glide Solver 410 and the constraint databases 815, 816, 817 . . . 819. In this configuration, like the last, the Glide Controller 144 is also the Requesting Device 811a.

In FIG. 8B, the Requesting Device 811a is shown as a sub component of the Glide Controller 144. In this way, the Glide Controller 144 may be receiving the requested route from the internal Requesting Device 811a. An example of this situation may include the Glide Controller 144 optimizing for the next x-miles, without receiving an ending destination.

In FIG. 8B, the Request Manager 812 and Glide Solver 410 are hosted locally on the Glide Controller 144. This means that computation carried out by the Route optimizer 420 and the Elevatier 430 may occur locally on the Glide Controller 144.

In FIG. 8B, the constraint databases 815, 816, 817 . . . 819 are shown as existing locally on the Glide Controller 144. It would follow that in this configuration, the Glide Controller 144 would be operating in the stand-alone mode, where the Glide Controller 144 may only communicate 160 with the Glide Servers 170 to apply firmware updates and database 815, 816, 817 . . . 819 data updates.

FIG. 8C depicts yet another possible variation of the Glide Controller 144 within the Glide System 100. In FIG. 8C, the Glide Controller may include the function blocks previously discussed, the Request Manager 812, and the Glide Solver 410, but may not be the Requesting Device 811b.

In the FIG. 8C variation, the Requesting Device 811a may be a module in the Glide Controller 144 (similar to FIG. 8A, FIG. 8B), or the Requesting Device 811b may be a User accessing the Glide System 100 via the Glide User Interface 143, or the Requesting Device 811b may be a device similar to that of the Glide User Interface 143 (discussed in earlier sections). A User's 141 cellular phone, tablet, or laptop may be used as the Requesting Device 811b. The Requesting Device 811b may not necessarily be installed in the Glide enabled device 131, 132 . . . 139, 140, 150, or it may not be integrated into the Glide Controller 144. The Requesting Device 811b may be connected via a wireless communications protocol and the Glide WAN 160 to the Glide Controller 144 or directly to the Request Manager 812.

FIG. 8A-8C should not serve as limiting or exclusive examples of variations to the Glide Controller. Other examples could include a variation where the Glide Servers 110 hold all of the functional blocks including the Request Manager 812, the Glide Controller 410, and the constraint databases 815, 816, 817 . . . 819. In this variation, the computation carried about by the Glide Solver 410 would be carried out on the Glide Servers 110, and the results would be sent back to the Glide Controller 144, which may serve simply as a Glide WAN 120 terminal for the Glide User Interface 143 in a Glide enabled device 131, 132 . . . 139, 140, 150.

It should be noted that the variations discussed above are not mutually exclusive. For one route optimization, the variation shown in FIG. 8A may hold, where the Glide Controller 144 is also the Requesting Device 811a (e.g., the User 141 enables the Glide Controller 144 to optimize for the next x-miles along the current route). That same Glide Controller 144 for its next route optimization task may assume the variation shown in FIG. 8C where the Requesting Device 811b is the User's 141 cellular device that is requesting a route optimization from the Glide Controller 144 and the Glide System 100.

### V. Operational Modes and Communications

The different modes of operation for the Glide System 100 will now be expanded on. The Glide System 100 may have multiple different modes that a Glide Controller 144 may operate in, and any Glide Controller 144 may operate in multiple different modes at once. These are different from the Glide Controller 144 variations discussed in the previous section.

In the connected, subscription-based mode, a Glide Controller 144 may communicate via the Glide WAN 120 with the Glide Servers 110 to obtain the information necessary for the Glide Solver 410 to optimize the request route for the desired parameters. In this mode, the Glide Solver 410 may use available data; vehicle models; traffic models and vehicle State of Charge models (for hybrid or electric vehicles) to calculate acceleration points; speed targets, optimal lanes when to apply a certain power train (internal combustion versus electric versus both); when to apply regenerative deceleration; and which gears to use for maximum efficiency. This is an example of parameters and solutions the Glide Solver 410 may use and carry out; it should by no means serve as an exclusive list for what the Glide Solver 410 and Glide System 100 may do.

In the stand-alone application, the Glide Controller 144 in the Glide enabled device 131, 132 . . . 139, 140, 150 may not communicate 160 with the Glide Servers 110, but may rather solve the route optimization using data included locally on the Glide Controller 144. In this way, the Glide Controller 144 would not receiver data from the Glide Servers 110 that is pertinent to solving the route optimization. This stand-alone configuration may allow for a Glide Controller 144 to download firmware updates from the Glide Servers 170. These firmware updates may include firmware that runs on a Glide Controller 144 as well as updates to the data stored locally on the Glide Controller 144 that the controller uses to solve the route optimization. This model may be compared to a GPS unit where the unit periodically downloads updates, but it relies on internal data for functionality.

Both the subscription-based mode and the stand-alone mode may be able to carry out the same functionality in terms of route optimization.

Both the subscription-based mode and stand-alone modes may be used with final destinations or simply with the Glide Controller 410 enabled to optimize the next x-miles on the current route.

With infrastructure to vehicle communication 160, a Glide Controller 144 may be operating on the traffic infrastructure 150 side of the Glide System 100 as well as in a Glide enabled vehicle 131, 132 . . . 139, 140. The infrastructure may solve for parameters including but not limited to vehicle speeds; optimal lanes for traffic flow and throughput; speed smoothing and vehicle spacing; occupancy or vehicle type by lanes; traffic light sequencing based on flow patterns; and traffic behavior alteration for crashes and emergency vehicles. A Glide Controller 144 operating on the traffic infrastructure 150 may send instructions to alter driving behavior to Glide Controllers 144 operating in Glide enabled vehicles 131, 132 . . . 139, 140.

With this communication 160 from the transportation infrastructure to the vehicle, the Glide System 100 may be able to instruct vehicles to switch lanes or slow down to increase or meet a desired throughput of a particular area along a route. Additionally, the traffic infrastructure may be able to send instructions that will allow lane clearing for an accident ahead of a Glide enabled vehicle's 131, 132 . . . 139, 140 current location or for an emergency/special vehicle approaching a Glide enable vehicle's 131, 132 . . . 139, 140 location.

The infrastructure to vehicle communication 160 may also allow the traffic infrastructure to speed smooth traffic in real-time or space vehicles for optimal travel efficiency.

In vehicle to vehicle communication (Symbiotic Vehicular Synchronizer), one Glide Controller 144 may send notifications about upcoming events to other Glide enabled vehicles 131, 132 . . . 139, 140 behind and around it. These notifications may be used by the receiving Glide Controllers 144 to adjust the optimized route in real time.

Vehicle to vehicle communication allows the optimized route to be a fluid solution that adjusts for real time data. This differs from current solutions that may require all information to be routed through system servers before clients may use the information. In allowing for real-time vehicle to vehicle communication, the Glide System may be proactive about route decisions based on information close in time and proximity to a Glide enabled vehicle 131, 132 . . . 139, 140.

Vehicle to vehicle communication may also occur via the Glide Servers. In this communication embodiment, a Glide enabled vehicle 131, 132 . . . 139, 140 may communication information to the Glide Servers 110, 170, which may then communicate necessary information to other Glide enabled vehicles 131, 132 . . . 139, 140. The communication 160 to and from the Glide Servers 110, 170 and the Glide enabled vehicles 131, 132 . . . 139, 140 may occur via the Glide WAN 120. In this way, the Glide System 100 may build fluid constraint databases that respond to changing environments.

Information shared by the Symbiotic Vehicular Synchronizer may include but is not limited to, traction failure of preceding vehicles (slippery section of a lane); traffic for the next y-miles along the current route or routes close in proximity to the current location of the vehicle; vertical motion and disturbances (bumps and potholes); breakdowns and accidents, for route and lane avoidance; Glide enabled vehicle locations for convoy opportunities and enhanced diving.

It should be noted that all modes of operation for the Glide System may use the vehicular sensor suite that may be integrated into the vehicle.

### VI. Modifications and Enhancements

As with any system involved with a complex task, there are always additions that can be made. The following serves as a short list of selected features that the Glide System 100 may employ to increase the completeness of the system.

The Glide System 100 and Glide Controller 144 may include the ability to provide supplemental information regarding the requested or optimized route. This may include functionality to plan out rest stops where the route plan may include when and where to refuel/recharge; which power plant to refuel/recharge (in a hybrid topology); and rest stops and food options. The Glide System 100 and Glide Controller 144 may provide supplemental information including but not limited to, rest-stop information, food services information, refueling and/or recharging information, and lodging information.

The ability of the Glide System 100 to provide recommendations on where to refuel and which power plant to replenish (in a hybrid topology) may be a necessary add-on for hypermiling. The variation in gasoline prices coupled with the sporadic placement of charging stations means there is a large amount of variation in the refueling/recharging plan for a route, especially a lengthy route.

The Glide System 100 may be able to compare gasoline prices for the next z-miles along the route with the availability of charge stations and their costs. This refueling station analysis may then be compared to the length of the route and the current state of the power plant sources (gasoline level and battery charge level). The Glide Controller 144 may then make a decision on the most optimal place to refuel at, given the route preferences. This analysis may change the way the Glide Solver 410 calculates the acceleration schedule for the vehicle

An example of route manipulation due to refueling options could be the following. If the Glide System 100 determines the next gasoline station prices to be expensive relative to another much closer to the final destination, the Glide Controller 144 may choose to have the Glide Solver 410 re-optimize the route, but this time the Glide Solver 410 may be instructed to weight the power plant usage towards a heavier usage of the electric powertrain. In this way, the Glide Controller 144 will save fuel in anticipation of bypassing the more expensive refueling station in favor of the refueling station close to the final destination.

The Glide System 100 may include the ability to optimize for holistic cost versus time balancing which may include HOV/Toll lanes and casual carpool pickups and drop-offs. This could also include a time flexibility parameter for situations like urgent meetings, concerts or other time sensitive activities.

The Glide System 100 may include the ability to estimate and adjust for trailering and other vehicle alterations that may be outside of the standard vehicle models. The Glide System 100 may also include the ability to adjust for weather considerations: snow, rain wind, etc. This may include the consideration of snow-chains or whether or not the vehicle is all-wheel-drive equipped and if a route requires that or not.

### VII. Glide User Interface

The above discussions have included references to a Glide User Interface 143. This interface may be embodied in any number of different ways. In a general sense, the Glide User Interface 143 may refer to a module capable of providing the User 141 a way to import route information into the Glide Controller 144. More specifically, the Glide User Interface 143 may be a visual feedback device with tactile or virtual buttons capable of reading data in and outputting data.

The screen depictions discussed here should not serve as limiting or exclusive matter, but rather they should serve as examples to aid in the explanation of how the Glide User Interface 143 may function and show data.

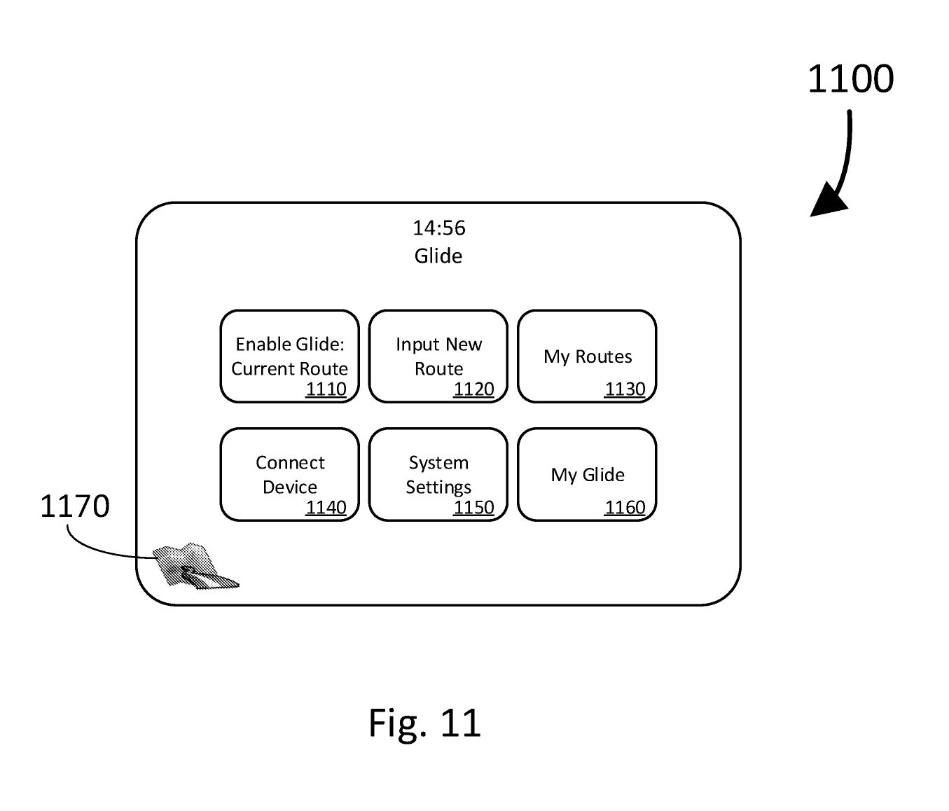

FIG. 11 depicts a possible screen that a User 141 could be shown while interfacing with the Glide User Interface 143. 1100 may be generally referred to as the home screen. This is the screen that the User 141 may be returned to, upon requesting so, during operation of the Glide User Interface 143.

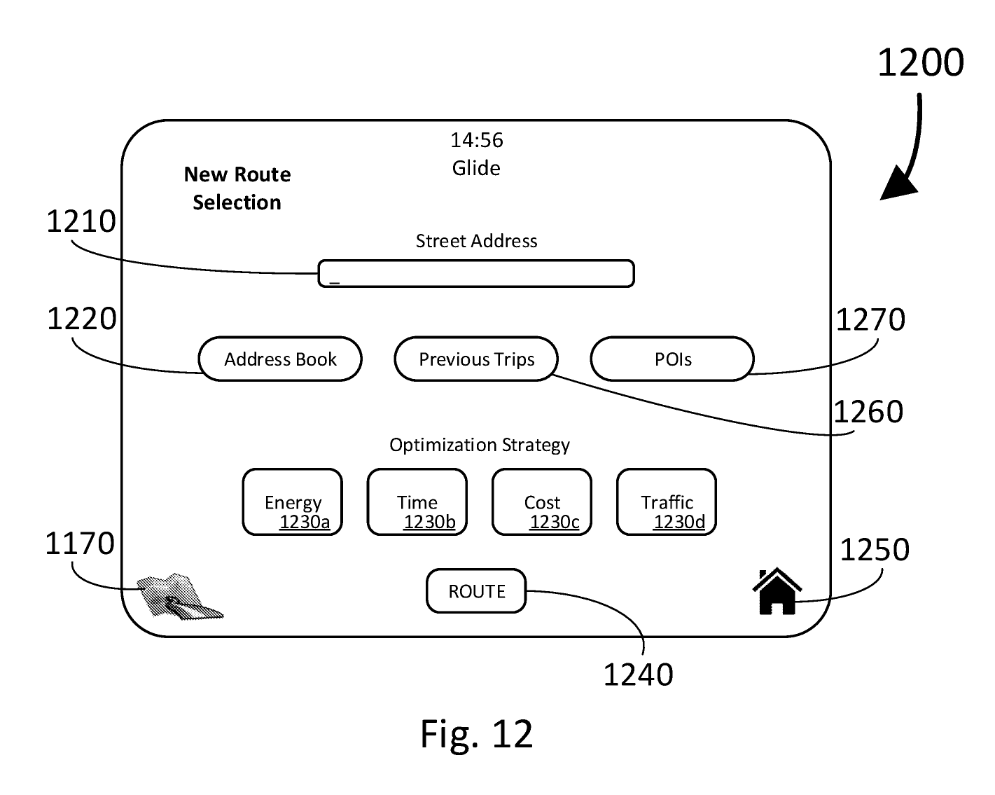

FIG. 11 depicts a possible home screen 1100 with multiple choices for the User 141. If the User 141 does not want to input a final destination, the User 141 may select choice 1110, which may request that the Glide System 100 operate without an end destination and rather optimize for the next x-miles. The User 141 may selection choice 1120 which may send the User 141 to a screen FIG. 12 that may prompt the User 141 for more information about the new route 1200.

FIG. 11 may also have a My Routes selection 1130 that when selected may show the User 141 the previous routes the User 141 has selected as well as routes or destinations the User 141 has saved in an Address Book. The Address Book may hold destinations as well as save routes. An example of this could include the Address Book holding the simple address of the User's 141 office building and holding the saved route to the office building with the route preferences that the User 141 usually selects for the route to the office building.

FIG. 11 may also present the User 141 with a Connect Device selection 1150, which when selected, may allow the User 141 to connect an eligible device to the Glide Controller 144. The User 141 may be presented with a System Settings 1150 selection, where the settings for the Glide User Interface 143 and the Glide Controller 144 may be altered. The User 141 may also be presented with a My Glide selection 1160, which may allow the User 141 to view and their Glide Profile.

FIG. 11 may also present the User 141 with a Map selection 1170 which, when selected, may take the User 141 to a map view that may show the location and current statics of the vehicle. This may not necessarily enabled the Glide System 100.

FIG. 12 was referenced above when discussing new route information. FIG. 12 depicts a possible screen that may generally be referred to as the New Route Selection screen 1200. The New Route Selection 1200 may include multiple ways and selections for the User 141 to fill in with regards to the new route. The New Route Selection 1200 may prompt the User 141 with a field 1210 to input the street address of the destination. When 1210 is selected, an on screen keyboard may present itself to aid the User 141 in inputting data. Additionally, the street address 1210 may be taken in using voice commands or the native driver interface that is installed in the vehicle.

The New Route Selection 1200 may present the User 141 with options to access previously stored addresses, trips, and points of interest (POIs) 1220, 1260, 1270.

Selection 1220 in FIG. 12 may allow the User 141 to access previously stored address. After selecting an address from the Address Book, the User 141 may be returned to the New Route Selection screen 1200 to input the preferred optimization for the New Route.

Selection 1260 in FIG. 12 may allow the User 141 to access previously completed or stored trips. After selecting a previously stored trip, the User 141 may be returned to the New Route Selection screen 1200 to input the preferred optimization for the new route. It may also be possible that the previously stored trip selection may include the optimization and route preferences from that trip. These preferences may already be selected or highlighted when the User 141 is returned to the New Route Selection screen 1220.

Selection 1270 in FIG. 12 may allow the User 141 to access a database of points of interest. After selecting a point of interest, the User 141 may be returned to the New Route Selection screen 1200 to input the preferred optimization for the New Route.

FIG. 12 may also present the User 141 with route optimization selections 1230a, 1230b, 1230c, 1230d. These choices may include but are not limited to energy 1230a, time 1230b, cost 1230c, and traffic 1230d. The User 141 may be able to choose any number of optimization strategies for the new route. It may be that the first strategy selected will be the highest priority, and the last strategy selected will be the lowest priority.

FIG. 12 may also present the User 141 with a Route selection 1240, which when selected may send the selected information from the above discussion to the Glide System as a Requested Route.

FIG. 12 the New Route Selection screen 1200 may also have selections for the Map screen 1170 and the home screen 1250. The Map selection 1170 which, when selected, may take the User 141 to a map view that may show the location and current statics of the vehicle. This may not necessarily enabled the Glide System 100. The home selection 1250, when selected, may return the User 141 to the home screen 1100.

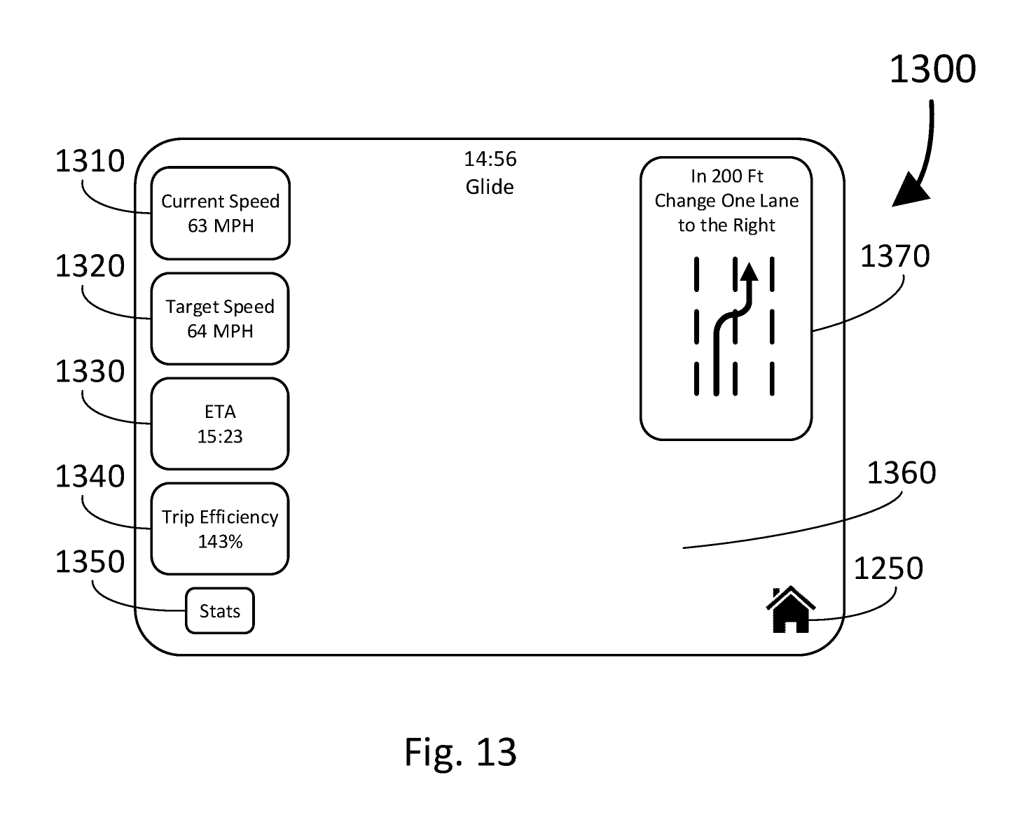

FIG. 13 shows a possible depiction of the guidance screen for the Glide User Interface 143. 1300 may be generally referred to as the Guidance Screen. The Guidance Screen 1300 may include information about the vehicle and the current route.

The Guidance Screen 1300 may display the current 1310 and target 1320 speeds for the vehicle. The target speed 1320 may represent the spatially next data point calculated by the Glide Solver 410 along the route.

The Guidance Screen 1300 may display the systems calculated estimated time of arrival to the destination (if applicable). If the Glide System 100 is operating without a final destination, this piece of information may not be displayed.

The Guidance Screen 1300 may display current efficiency of the trip, normalized against similar trips or a best estimated trip that doesn't use the Glide System 100. The Guidance Screen 1300 may also have a Stats selection 1350 that may take the User 141 to another screen that displays more in depth stats for the trip.

The Guidance Screen 1300 may also display information to alter the driver to the next driving operation that should be carried out as part of the trip plan. The map area 1360 of the Guidance Screen 1300 may display any number of different types of maps (multiple at one time or a single map at a time).

In addition to a map 1360, the Guidance Screen 1300 may display a Next Step section 1370 for the route. As shown in FIG. 13 this may include written instructions for the next step as well as a visual representation. Additionally, the Glide System may give an auditory message of the next step.

The information the Guidance Screen 1300 displays should not be limited to the above discussion. Other information including battery state of charge, distance to next refueling station, and surrounding vehicles using the Glide System may also be displayed on the Guidance Screen 1300.

### VIII. Glide Application and Web Service

The Glide User Interface 143 installed in a Glide enabled device 131, 132 . . . 139, 140, 150 may not be the only device capable of displaying Glide System information. As discussed above, there may be many devices capable of acting as a Glide User Interface 143 that is not necessary installed in a Glide enabled device 131, 132 . . . 139, 140, 150.

Interaction between the User 141 and a Glide User Interface 143 may occur via a Glide Application or a Glide Web Service. The Glide Application or Web Service may run generally, on a computing device, and specifically, on a device with tactile or virtual buttons capable of receiving input and a method for reading information out to an operator. Devices may include but are not limited to, cellular telephones, tablet computers, laptop computers, desktop computers, and other variations of these devices.

The Glide Application or Web Service may have the same functionality as the Glide User Interface described in the previous section. The Glide Application or Web Service may have a home screen 1100 similar to the one shown in FIG. 11. It may be possible for the Glide Application or Web Service to take in route information from an operator using a screen similar to the New Route Selection screen 1200 shown in FIG. 12. The Glide Application or Web Service may then store or send this information to a Glide Controller 144. Additionally, the Glide Application or Web Service may be able to display real-time information pertaining to an in progress route using a screen similar to the Guidance Screen 1300 shown in FIG. 13.

The Glide Application or Web Service may connect to the Glide Servers 110, 170 and directly to a Glide Controller 144. The device running the Glide Application or Web Service may communicate with the Glide Servers 110, 170 using any number of communication methods including but not limited to, 3G, 4G, or 5G cellular communication; or WiFi. The device running the Glide Application or Web Service may communicate with the Glide Controller 144 using any number of communication methods including but not limited to, 3G, 4G, or 5G cellular communication; WiFi, DSRC, Bluetooth, or ZigBee.

### IX. Glide Profile

The Glide System 100 may allow Users 141 to create profiles that may be saved on the Glide Servers 110, 170. These profiles may include saved information pertaining to a particular User 141 or driver, or the profiles may include saved information pertaining to a particular vehicle. All types of Glide Profiles may save information pertaining to previous trips, saved addresses, saved settings/preferences, and accumulated statistics. Glide Profiles for either a User 141 or a Glide enabled device 131, 132 . . . 139, 140 should not be limited in scope by the current discussion.

A User 141 may be able to access a particular Glide Profile from any number of Glide Controllers 144. This may allow a User 141 to access a particular Glide Profile from a Glide Controller 144 or Glide User Interface 143 that may not necessarily be installed in a Glide enabled device 131, 132 . . . 139, 140 owned by the User 141.

Two examples of accessing a Glide Profile that may not be owned by the primary account holder may include using the Glide System 100 in a Glide enabled rental car, or using the Glide System 100 in a friend's Glide enabled vehicle. Continuing with the rental car example; a User 141 may be able to access saved routes, saved addresses, saved preferences, and saved statistics via their Glide Profile so that they may use the full extent of the Glide System 100, while driving a Glide enabled rental vehicle.

It may be possible for a User 141 to temporarily transfer paid Glide services to another Glide Controller 144. An example of this may include, the rental car company pays only for the stand-alone Glide service, but the current User 141 (renter of the car) pays for the subscription based model with constant access to the Glide Servers 110. In this example, the Glide Controller 144 in the rental car may be able to access the Glide Servers 110, while the User's 141 Glide Profile is active on the Glide Controller 144 in the rental vehicle.

It may be possible to access a Glide Profile from devices other than a Glide User Interface 143. As discussed in the previous section, a Glide Application running on a computing device, may have the capabilities to access the Glide Servers 110, 170, to add and retrieve Glide Profile information. In this way, it may be possible for a User 141 to access a Glide Profile from a cellular device to input a destination or route parameters, save the destination or route parameters, and then access this data from a Glide User Interface 143 in a Glide enabled device 131, 132 . . . 139, 140.

In sum, the present invention provides a system and methods for optimizing a vehicle's route and Glide schedule using information related but not limited to traffic, time, cost, weather, vehicular sensor data, and refueling/recharging. The advantages of such a system include the ability to optimize and adjust a travel route based on a limitless number of parameters and inputs that would otherwise not be possible especially if these parameters and inputs were beyond the line of sight of the vehicle's operator.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. In a computerized, customizable route-based glide solver, a method for dynamically and efficiently controlling a vehicle along a route in real-time, the method comprising:
receiving a requested route defined by at least one route parameter;
optimizing the requested route using vehicular optimization criteria, wherein the optimization includes analysis of at least one data set pertaining to the requested route;
providing a vehicular glide schedule for discrete points along the requested route in response the route optimization; and
dynamically adjusting the vehicular glide schedule in response to a change in one or more of the at least one data set.

2. The method of claim 1 further comprising dynamically adjusting the vehicular glide schedule in response to data provided by at least one vehicular sensor.

3. The method of claim 2 wherein the at least one vehicular sensor includes at least one of a global positioning system (GPS), a radar and an optical sensor.

4. The method of claim 1 wherein the vehicular glide schedule includes at least one of an acceleration schedule, an engine revolutions-per-minute (rpm) schedule, a motor rpm schedule, a gear selection schedule, a power train selection schedule, a braking schedule and a regeneration schedule.

5. The method of claim 1 wherein the at least one route parameter includes at least one of a starting location, a waypoint location and an ending location.

6. The method of claim 1 wherein a user provides the requested route.

7. The method of claim 1 wherein the at least one data set includes at least one of an elevation data set, a speed limit data set, a road curvature data set, a drag force data set, a road conditions data set, a traffic data set and a weather data set.

8. The method of claim 1 further comprising receiving at least one of the at least one data set from an external server.

9. The method of claim 1 wherein the optimization criteria includes at least one of vehicular operating cost, route travel time and toll fees.

10. The method of claim 9 wherein the vehicular operating cost includes one or more of a fuel cost, a charging cost, and a maintenance cost.

11. The method of claim 1 wherein a user provides the optimization criteria.

12. The method of claim 1 wherein the route optimization includes minimizing the at least one optimization criteria using at least one of an inequality constrained norm-2 solver and a piecewise linear solver.

13. The method of claim 1 further comprising providing supplemental route information regarding the optimized requested route.

14. The method of claim 13 wherein the supplemental route information include at least one of rest-stop information, food service information, and lodging information.

15. A computerized, customizable route-base glide solver configured to dynamically and efficiently control a vehicle along a route in real-time, the glide solver comprising:
a route optimizing interface configured to receive a requested route defined by at least one route parameter; and
a route optimizer configured to:
optimize the requested route using vehicular optimization criteria, wherein the optimization includes analysis of at least one data set pertaining to the requested route;
provide a vehicular glide schedule for discrete points along the requested route in response to the route optimization; and
dynamically adjust the vehicular glide schedule in response to a change in one of the at least one data set.

16. The glide solver of claim 15 wherein the route optimizer is further configured to dynamically adjust the vehicular glide schedule in response to data provided by at least one vehicular sensor.

17. The glide solver of claim 15 wherein the vehicular glide schedule includes at least one of an acceleration schedule, an engine revolutions-per-minute (rpm) schedule, a motor rpm schedule, a gear selection schedule, a power train selection schedule, a braking schedule and a regeneration schedule.

18. The glide solver of claim 15 wherein the at least one data set includes at least one of an elevation data set, a speed limit data set, a road curvature data set, a drag force data set, a road conditions data set, a traffic data set and a weather data set.

19. The glide solver of claim 15 wherein the glide solver is included in an external server.

20. The glide solver of claim 15 wherein the optimization criteria includes at least one of vehicular operating cost, route travel time and toll fees.

21. The glide solver of claim 20 wherein the vehicular operating cost includes one or more of a fuel cost, a charging cost, and a maintenance cost.
